(19) United States
(12) Patent Application Publication
(10) Pub. No.: US 2015/0364796 A1
(43) Pub. Date: Dec. 17, 2015

(54) LOW TEMPERATURE ELECTROLYTE FOR HIGH CAPACITY LITHIUM BASED BATTERIES

(71) Applicant: Envia Systems, Inc., Newark, CA (US)

(72) Inventors: Bing Li, Union City, CA (US); Shabab Amiruddin, Menlo Park, CA (US)

(21) Appl. No.: 14/835,138

(22) Filed: Aug. 25, 2015

Related U.S. Application Data
(63) Continuation of application No. 13/325,367, filed on Dec. 14, 2011.

(51) Int. Cl. H01M 10/0569; H01M 4/485; H01M 4/505; H01M 4/525; H01M 10/0525; H01M 4/131

(52) U.S. Cl. CPC H01M 10/0569; H01M 10/0525; H01M 4/131; H01M 4/505; H01M 4/525; H01M 4/485; H01M 2220/20; H01M 2300/0034; H01M 2004/028

(57) ABSTRACT

Electrolytes for lithium based batteries are described with good temperature tolerance over appropriate temperature ranges for uses in vehicles. In particular, the electrolytes are suitable for high voltage operation over 4.4V and can provide high rate performance. The electrolytes generally comprise a solvent that is a mixture of ethylene carbonate, dimethyl carbonate and ethylmethyl carbonate. Alternatively, a solvent combination of fluoroethylene carbonate and dimethyl carbonate was used. A primary lithium salt is includes at a concentration greater than about 1.05M. The electrolyte generally also comprises a lithium salt additive. The electrolytes can provide some battery capacity down to at least −40° C. while providing good performance also at elevated temperatures of 45° or more, and the corresponding batteries can be cycled to several thousand cycles.

### CROSS REFERENCE TO RELATED APPLICATIONS

This application is a continuation of copending U.S. patent application Ser. No. 13/325,367 filed on Dec. 14, 2011 to Li et al., entitled “Low Temperature Electrolyte for High Capacity Lithium Based Batteries,” incorporated herein by reference.

### FIELD OF THE INVENTION

The inventions, in general, are related to electrolytes for lithium based batteries, e.g., lithium ion batteries, that provide appropriate performance down to very low temperatures with high capacity lithium metal oxide cathode active materials. The inventions are further related to low temperature tolerant electrolytes that can cycle stably for a very large number of cycles, and in some embodiments are suitable for high voltage cycling.

### BACKGROUND

Lithium batteries are widely used in consumer electronics due to their relatively high energy density. Rechargeable batteries are also referred to as secondary batteries, and lithium ion secondary batteries generally have a negative electrode material that incorporates lithium when the battery is charged. For some current commercial batteries, the negative electrode material can be graphite, and the positive electrode material can comprise lithium cobalt oxide (LiCoO₂). In practice, only a modest fraction of the theoretical capacity of the positive electrode active material generally can be used. At least two other lithium-based positive electrode active materials are also currently in commercial use. These two materials are LiMn₂O₄, having a spinel structure, and LiFePO₄, having an olivine structure. These other materials have not provided any significant improvements in energy density.

Lithium based batteries are generally classified into two categories based on their application. The first category involves high power battery, whereby lithium based battery cells are designed to deliver high current (Amperes) for such applications as power tools and Hybrid Electric Vehicles (HEVs). However, by design, these battery cells are lower in energy since a design providing for high current generally reduces total energy that can be delivered from the battery. The second design category involves high energy batteries, whereby lithium based battery cells are designed to deliver low to moderate current (Amperes) for such applications as cellular phones, lap-top computers, Electric Vehicles (EVs) and Plug in Hybrid Electric Vehicles (PHEVs) with the delivery of higher total capacity.

Electrolytes provide for ionic conductivity through the batteries between the cathodes and anodes. For most commercial batteries, a liquid electrolyte is used. The properties of the electrolyte can influence significantly the battery performance. For outdoor use, such as for vehicles, the batteries are subjected to conditions spanning over a wide temperature range. It is also desirable for the batteries to operate over a large number of charge-discharge cycles so that the batteries can provide a larger economic value.

### SUMMARY OF THE INVENTION

In a first aspect, the invention pertains to an electrolyte for a lithium based battery, e.g., a lithium battery or a lithium ion battery, comprising from about 1.05M to about 2.0M LiPF₆, LiBF₄ or combinations thereof, a solvent consisting of ethylene carbonate, dimethyl carbonate and ethylmethyl carbonate and one or more lithium salt additives. The solvent generally has a weight ratio of ethylene carbonate (EC) to dimethyl carbonate (DMC) of about 1:1 to about 1:4 and an ethylmethyl carbonate (EMC) concentration of from about 5 weight percent to about 40 weight percent of the total weight of the electrolyte. The one or more lithium salt additives is in a total amount from about 0.01 weight percent to about 10 weight percent of the total weight of the electrolyte. Lithium batteries and/or lithium ion batteries can comprise these electrolytes. In some embodiments, the LiPF₆, LiBF₄ or combinations in the electrolyte has a concentration of about 1.05M to about 1.6M. The weight ratio of ethylene carbonate to dimethyl carbonate is from about 1:1.25 to 1:3 and the ethylmethyl carbonate concentration is from about 10 weight percent to about 30 weight percent of the total weight of the electrolyte. The lithium salt additive can be represented by the formula:

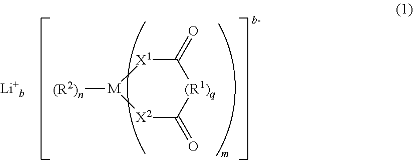

where b is the charge of the anion, m is a number from 1 to 4, n is a number from 1 to 8, q is 0 or 1, M is a transition metal or an element selected from groups 13-15 of the periodic table, R¹ is an organic group, R² is a halogen or an organic group, X¹ and X² are independently O, S or NR⁴, and R⁴ is a halogen or an organic group. In some embodiments, lithium salt additive comprises lithium difluoro oxalato borate (LiDFOB), lithium bis(oxalato)borate (LiBOB), lithium fluorododecaborate (Li₂B₁₂HₓF₁₂₋ₓ(x=0-3)), lithium (bis)trifluoromethane sulfonimide, or a combination thereof. In some embodiments, the electrolyte comprises one or more non-ionic organic additives in a total amount of no more than about 30 weight percent of the total weight of the electrolyte. The non-ionic organic additive is selected from the group consisting of N,N-diethylamino trimethylsilane, 2,5-dihydrofuran, ethylmethyl sulfone, fluoroethylene carbonate, gamma-butyrolactone, monomer of polyethylene oxide, monomer of polyvinylidine fluoride, and mixtures thereof. In one embodiment, the non-ionic organic additive is fluoroethylene carbonate. The invention also pertains to a lithium based battery, comprising a positive electrode comprising a lithium intercalation material, a negative electrode, a separator between the negative electrode and the positive electrode, and the electrolyte described above. In some embodiments, the battery has a discharge capacity at −30 degrees Celsius that is at least about 40% of the room temperature discharge capacity. The battery can have a discharge capacity at −40 degrees Celsius that is at least about 25% of the room temperature discharge capacity. The battery in some embodiments can maintain at least 60% discharge capacity at 45 degree Celsius after cycling for 1500 cycles when discharged from 4.35 V to 2.2 V at 1 C.

In another aspect, the invention pertains to a lithium based battery, comprising a positive electrode comprising a lithium intercalation material, a negative electrode, a separator between the negative electrode and the positive electrode, and an electrolyte comprising LiPF₆ and/or LiBF₄, a solvent consisting of ethylene carbonate, dimethyl carbonate and ethylmethyl carbonate, and one or more lithium salt additives. The negative electrode can comprise, for example, lithium metal, a lithium alloy, or lithium intercalation/alloying material. In some embodiments, the negative electrode comprises graphitic carbon, silicon based material, or a combination thereof. In some embodiments, the battery has a specific capacity of at least about 80 mAh/g relative to the weight of the positive electrode active material when discharged at −30° C. from 4.5V to 2 V at a rate of C/10. In some embodiments, the positive electrode comprises a lithium metal oxide approximately represented by the formula Li_{1+b}Ni_{α}Mn_{β}Co_{γ}A_{δ}O_{2-z}F_{z}, where b ranges from about 0.01 to about 0.3, α ranges from about 0 to about 0.4, β range from about 0.2 to about 0.65, γ ranges from 0 to about 0.46, δ ranges from 0 to about 0.15 and z ranges from 0 to about 0.2 with the proviso that both α and γ are not zero, and where A is Mg, Sr, Ba, Cd, Zn, Al, Ga, B, Zr, Ti, Ca, Ce, Y, Nb, Cr, Fe, V, Li or combinations thereof. In some embodiments, the LiPF₆, LiBF₄ or combinations in the electrolyte has a concentration from about 1.05M to about 2.0M.

In a further aspect, the invention pertains to a lithium based battery comprising a positive electrode, a negative electrode, a separator between the negative electrode and the positive electrode, and an electrolyte comprising lithium ions. In some embodiments, the positive electrode comprises a lithium metal oxide approximately represented by the formula Li_{1+b}Ni_{α}Mn_{β}Co_{γ}A_{δ}O_{2-z}F_{z}, where b ranges from about 0.01 to about 0.3, α ranges from about 0 to about 0.4, β range from about 0.2 to about 0.65, γ ranges from 0 to about 0.46, δ ranges from 0 to about 0.15 and z ranges from 0 to about 0.2 with the proviso that both α and γ are not zero, and where A is Mg, Sr, Ba, Cd, Zn, Al, Ga, B, Zr, Ti, Ca, Ce, Y, Nb, Cr, Fe, V, Li or combinations thereof. In addition, the electrolyte can comprise from about 1.05M to about 2.0M of LiPF₆ and/or LiBF₄, a solvent consisting of ethylene carbonate, dimethylcarbonate and ethylmethyl carbonate with a weight ratio of ethylene carbonate to dimethyl carbonate of 1:1 to 1:4 and ethylmethyl carbonate concentration is from about 5 weight percent to about 40 weight percent of the total weight of the electrolyte. The negative electrode can comprise, for example, lithium metal, a lithium alloy, or lithium intercalation/alloying material. In some embodiments, the negative electrode comprises graphitic carbon, silicon based material, or a combination thereof. In some embodiment, the lithium metal oxide of the positive electrode can be approximately represented by a formula of xLi₂M′O₃.(1−x) LiMO₂, where M′ represents one or more metal ions having an average valance of +4 and M represents one or more metal ions having an average valance of +3, and 0.03<x<0.6. The battery has a discharge capacity at −30 degrees Celsius that is at least about 40% of the discharge capacity at room temperature and at −40 degrees Celsius that is at least about 25% discharge capacity at room temperature.

In yet another aspect, the invention pertains to a lithium based battery that comprises a positive electrode comprising a lithium metal oxide having a specific discharge capacity of at least about 200 mAh/g at a rate of C/3 when discharged from 4.5 V to 2V, a negative electrode, a separator between the negative electrode and the positive electrode, and an electrolyte. The electrolyte for the lithium ion battery comprises from about 1.05M to about 2.0M LiPF₆, LiBF₄ or combinations thereof, a solvent consisting of fluoroethylene carbonate and dimethyl carbonate with a weight ratio of fluoroethylene carbonate to dimethyl carbonate of about 1:1 to about 1:4, and one or more lithium salt additives in a total amount from about 0.01 weight percent to about 10 weight percent of the total weight of the electrolyte. The battery maintains at least 75% of its discharge energy density at the 2000th cycle at 1 C charge and 2 C discharge between 4.24V and 2.73V. In some embodiment, the battery maintains at least 73% of its discharge energy density at the 3000^{th} cycle at 1 C charge and 2 C discharge between 4.24V and 2.73V. The negative electrode can comprise, for example, lithium metal, a lithium alloy, or lithium intercalation/alloying material. In some embodiments, the negative electrode comprises graphitic carbon, silicon based material, or a combination thereof. In some embodiment, the lithium metal oxide of the positive electrode can approximately be represented by the formula Li_{1+b}Ni_{α}Mn_{β}Co_{γ}A_{δ}O_{2-z}F_{z}, where b ranges from about 0.01 to about 0.3, α ranges from about 0 to about 0.4, β range from about 0.2 to about 0.65, γ ranges from 0 to about 0.46, δ ranges from 0 to about 0.15 and z ranges from 0 to about 0.2 with the proviso that both α and γ are not zero, and where A is Mg, Sr, Ba, Cd, Zn, Al, Ga, B, Zr, Ti, Ca, Ce, Y, Nb, Cr, Fe, V, Li or combinations thereof, In some embodiments, the weight ratio of fluoroethylene carbonate to dimethyl carbonate is from about 1:1.25 to 1:3. The lithium salt additive of the electrolyte is represented by the formula:

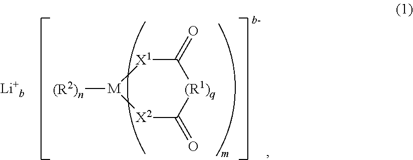

where b is the charge of the anion, m is a number from 1 to 4, n is a number from 1 to 8, q is 0 or 1, M is a transition metal or an element selected from groups 13-15 of the periodic table, R¹ is an organic group, R² is a halogen or an organic group, X¹ and X² are independently O, S or NR⁴, and R⁴ is a halogen or an organic group. In some embodiments, the lithium salt additive comprises lithium difluoro oxalato borate (LiDFOB), lithium bis(oxalato)borate (LiBOB), lithium fluorododecaborate (Li₂B₁₂HₓF₁₂₋ₓ(x=0-3)), lithium (bis)trifluoromethane sulfonimide, or a combination thereof. In some embodiments, the electrolyte further comprises one or more non-ionic organic additives in a total amount of no more than about 30 weight percent of the total weight of the electrolyte. The non-ionic organic additive is selected from the group consisting of N,N-diethylamino trimethylsilane, 2,5-dihydrofuran, ethylmethyl sulfone, gamma-butyrolactone, monomer of polyethylene oxide, monomer of polyvinylidine fluoride, and mixtures thereof. In some embodiments, the battery has a discharge capacity at −30 degrees Celsius that is at least about 50% of the discharge capacity at room temperature. The negative electrode can comprise, for example, lithium metal, a lithium alloy, or lithium intercalation/alloying material. In some embodiments, the negative electrode comprises graphitic carbon, silicon based material, or a combination thereof. In some embodiment, the solvent of the electrolyte contains no more than about 0.5% carbonate including additional halogenated carbonates besides fluoroethylene carbonate and dimethyl carbonate. In some embodiments, the battery has a discharge capacity at −30 degrees Celsius that is at least about 50% of the discharge capacity at room temperature.

### BRIEF DESCRIPTION OF THE DRAWINGS

FIG. 1 is a schematic perspective view of an electrode stack useful for the formation of a battery.

FIG. 2 is a plot of conductivity of the electrolytes at different temperatures showing decreased conductivity with decreasing temperature.

FIG. 3 is a plot of complete forward and reverse cyclic voltammetry measurements of the sample electrolytes showing decreased stability with increasing amount of ethyl methyl carbonate (EMC) in the sample.

FIG. 4 is a plot of discharge capacity as percentage between the low temperature discharge capacity and the corresponding room temperature discharge capacity under different low temperature conditions of the batteries made from different electrolyte samples.

FIG. 5 is a plot of specific discharge capacity versus cycling number out to 1000 cycles at room temperature of the batteries made from different electrolyte samples cycled at C/3 rate between 2 to 4.5 V.

FIG. 6 is a plot of discharge capacity versus cycling number out to more than 1400 cycles from 2.2V to 4.35V at 45° C. of batteries with approximately 1 Ah design capacity made from different electrolyte samples.

FIG. 7 a plot of the cycling performance under fluctuating temperature conditions between 25° C. and −20° C., −30° C., or −40° C. of the batteries made from different electrolyte samples.

FIG. 8 is a plot of the cycling performance of a battery made from 30 wt % EMC under fluctuating temperature conditions between 20° C. and −20° C., −30° C., or −40° C.

FIG. 9 is a plot of conductivity versus salt concentration of electrolyte samples with different LiPF₆ salt concentrations.

FIG. 10 is a plot of the cycling performance under fluctuating temperature conditions between room temperature and −30° C., −35° C., or −40° C. of the batteries made from electrolyte samples with different LiPF₆ salt concentrations.

FIG. 11 is a plot of the cycling performance under fluctuating temperature conditions between room temperature and −20° C., −30° C., or −40° C. of the batteries made from electrolyte samples with different LiPF₆ salt concentrations and without EMC.

FIG. 12 are two plots of discharge capacity as percentage between the low temperature, i.e. −30° C. or −40° C. discharge capacity and the corresponding room temperature discharge capacity of the batteries made from electrolyte samples with different LiPF₆ salt concentrations.

FIG. 13 is a plot of specific capacity versus cycle number of the batteries made from electrolyte samples with different LiPF₆ salt concentrations cycled at different charge and discharge rates at room temperature.

FIG. 14 is a plot of specific capacity versus cycle number of the batteries made from electrolyte samples with different LiPF₆ salt concentrations cycled at 1 C during charge and at 2 C during discharge between 2 and 4.5 V at room temperature out to more than 200 cycles.

FIG. 15 is a plot of specific capacity versus cycle number of the batteries made from electrolyte samples with different LiPF₆ salt concentrations cycled at 1 C during charge and at 2 C during discharge between 2.73 and 4.24 V at room temperature out to more than 1500 cycles.

FIG. 16 is a plot of capacity versus cycle number of the batteries with 1 Ah capacity made from electrolyte samples without EMC or with FEC cycled at 1 C during charge and at 2 C during discharge between 2.73 and 4.24 V at room temperature out to 3000 cycles.

FIG. 17 is a plot of specific capacity versus cycle number of the batteries with 1 Ah capacity made from electrolyte samples with different LiPF₆ salt concentrations cycled at 1 C during charge and at 2 C during discharge between 2.73 and 4.24 V at 45° C. out to more than 1200 cycles.

### DETAILED DESCRIPTION OF PREFERRED EMBODIMENTS

Desirable electrolytes are described herein that provide an important range of properties. In particular the electrolytes have good high voltage stability and excellent low temperature functionality while supporting good room temperature and high temperature specific capacities and high rate battery performance. The improved electrolytes are also stable for long cycle numbers, which is very important for use with new high capacity lithium rich positive electrode active materials that have exceptional cycling properties at high capacity. Two classes of electrolytes are described herein based on two corresponding selected solvent systems. In some embodiments, the first solvent system for the first class of the improved electrolytes can comprise a mixture of ethylene carbonate, dimethyl carbonate and ethylmethyl carbonate. In additional or alternative embodiments, the second solvent system for the second class of the improved electrolytes comprises a mixture of fluoroethylene carbonate and dimethyl carbonate. The electrolytes generally comprise LiPF₆, LiBF₄ or combinations thereof as a primary lithium salt, along with one or more lithium salt stabilizing additives. The improved electrolytes can provide reasonable battery capacities down to at least −30° C., e.g. a capacity that is at least about 50% of the room temperature discharge capacity. In some embodiments, the improved electrolytes provide battery capacities down to −40° C. Furthermore, the electrolytes can support high rate discharges on the order of 5C with a reasonable discharge capacity, Thus, the electrolytes are suitable for use in automobile batteries, such as for electric vehicles, plug-in hybrid vehicles and hybrid vehicles that can be subjected to significant ranges of outside temperatures. As used herein as well as generally used in the battery arts, the term electrolyte refers to a salt solution while the solid salts dissolved in the solution are referred to as electrolyte salts.

In some embodiments, it is strongly desired for the batteries to have a long cycle life where the end of life is indicated by the particular drop in capacity below a selected threshold. For consumer electronics, some products have a desired cycle life of at least 300 cycles with acceptable capacity and power output. For electric power vehicles, hybrids and the like, the batteries represent a large cost for the vehicle, and a long cycle life, e.g., at least a thousand cycles, can be desired for the vehicle to be commercially suitable for large scale distribution. Use of the electrolytes described herein can improve the cycling performance of high voltage batteries so that their relatively high capacity can be exploited for a range of applications. In some embodiments, batteries employ the improved electrolyte maintain at least 70% capacity out to at least 1000 cycles. Additionally, the electrolytes are suitable for commercial scale use.

Lithium has been used in both primary and secondary batteries. An attractive feature of lithium metal for battery use is its light weight and the fact that it is the most electropositive metal, and aspects of these features can be advantageously captured in lithium-based batteries also. Certain forms of metals, metal oxides, and carbon materials are known to incorporate lithium ions into the material through intercalation, alloying or similar mechanisms. Lithium ion batteries generally refer to batteries in which the negative electrode active material is also a lithium intercalation/alloying material. If lithium metal itself is used as the anode, the resulting battery generally is referred to as a lithium battery. Lithium based batteries can be, for example, lithium batteries or lithium ion batteries. Desirable lithium rich mixed metal oxides are described further herein to function as electroactive materials for positive electrodes in secondary lithium ion batteries, although the desirable electrolytes described herein can be effectively used with other positive electrode active materials.

The batteries described herein are lithium-based batteries in which a non-aqueous electrolyte solution comprises lithium ions. For secondary lithium ion batteries during charge, oxidation takes place in the cathode (positive electrode) where lithium ions are extracted and electrons are released. During discharge, reduction takes place in the cathode where lithium ions are inserted and electrons are consumed. Similarly, the anode (negative electrode) undergoes the opposite reactions from the cathode to maintain charge neutrality. Unless indicated otherwise, performance values referenced herein are at room temperature, i.e., 23±2° C.

The word “element” is used herein in its conventional way as referring to a member of the periodic table in which the element has the appropriate oxidation state if the element is in a composition and in which the element is in its elemental form, M⁰, only when stated to be in an elemental form. Therefore, a metal element generally is only in a metallic state in its elemental form, i.e. elemental metal or a corresponding alloy of the metal's elemental form, i.e. metal alloy. In other words, a metal oxide or other metal composition, other than metal alloys, generally is not metallic.

When lithium based batteries are in use, the uptake and release of lithium from the positive electrode and the negative electrode induces changes in the structure of the electroactive material. As long as these changes are essentially reversible, the capacity of the material does not change. However, the capacity of the active materials is observed to decrease with cycling to varying degrees. Thus, after a number of cycles, the performance of the battery falls below acceptable values, and the battery is replaced. The degradation of performance with cycling can have contributions from the positive electrode, the negative electrode, the electrolyte, the separator or combinations thereof.

Some positive electrode active materials, including lithium rich metal oxides described herein, can be cycled with high capacity for a large number of cycles. Thus, it is desirable for the electrolyte used in corresponding batteries to be stable for a large number of cycles so that the electrolyte is not an important contributing factor to battery failure. Higher specific capacities can be accessed for some embodiments of cathode materials when higher voltages are used. In some embodiments, the positive electrode active materials are lithium rich relative to a LiMO₂ reference material, which can have high capacities. In some embodiments, it is desirable to charge the batteries to relatively high voltage, e.g., above 4.4V, and for these embodiments it is desirable for the electrolyte to be stable chemically at the high voltage. In some embodiments, it may be desirable for the electrolyte to be stable to 4.5V or higher, in other embodiments 4.6V and in further embodiments up to 4.8V or higher. A person of ordinary skill in the art will recognize that additional ranges of voltage cut offs within the explicit ranges above are contemplated and are within the present disclosure. The details of positive electrode active material used with the electrolytes described herein to construct corresponding high energy batteries are discussed further below.

It is useful to note that during charge/discharge measurements, the specific capacity of a material depends on the rate of discharge. The highest specific capacity of a particular material is measured at very slow discharge rates. In actual use, the actual specific capacity is less than the maximum value due to discharge at a faster rate. More realistic specific capacities can be measured using reasonable rates of discharge that are more similar to the rates encountered during actual use. For example, in low to moderate rate applications, a reasonable testing rate involves a discharge of the battery over three hours. In conventional notation this is written as C/3 or 0.33 C. Faster or slower discharge rates can be used as desired, and the rates can be described with the same notation. Performance results at higher rates are described in the Examples below.

The design of lithium based batteries, for example, lithium ion batteries, for use in vehicles provides significant design constraints on the batteries. In particular, the batteries in the vehicles operate over a large range in temperatures. For use of the batteries in a broad range of climates, it is desirable that the batteries generate a reasonable capacity down to a temperature of −30° C. and up to temperatures of 45° C. In some embodiments, it is desirable that the batteries generate a reasonable capacity down to a temperature of −40° C. and up to temperatures of 55° C. The functionality over the wide temperature range should be maintained for a large number of cycles, generally in the many hundreds of cycles and in some embodiments for several thousand cycles. For applications relating to vehicles, the batteries generally should be able to operate with reasonable capacities at moderate discharge rates for plug-in hybrid vehicles, and generally at rates up to 5 C the batteries should still provide acceptable performance. Lower peak discharge rates may be acceptable for applications such as use in pure electric vehicles.

Electrolytes for use at low temperatures have been formulated with equal volumes of ethylene carbonate, dimethyl carbonate and ethylmethyl carbonate (1:1:1) using 1M LiPF₆ salt. See Plichta et al., “A low-temperature electrolyte for lithium and lithium-ion batteries,” Journal of Power Sources 88 (2000) 192-196, incorporated herein by reference. The 1:1:1 carbonate blend electrolyte was used in batteries with lithium cobalt oxide with charge voltages up to 4.15V and was not tested for cycling stability. In contrast, the improved electrolyte described herein generally has a greater amount of dimethyl carbonate and a larger lithium salt concentration. The improved electrolyte described herein has good low temperature performance while also achieving high voltage stability as well as stability out for a very large number of charge/discharge cycles.

It has been suggested that under basic conditions, linear carbonates can undergo reactions involving carbonate exchange in which the alkoxy groups are exchanged. Such base catalyzed carbonate exchange reactions are described further in U.S. Pat. No. 6,492,064 to Smart et al., entitled “Organic Solvents, Electrolytes and Lithium Ion Cells With Good Low Temperature Performance,” incorporated herein by reference. Thus, a blend of symmetric carbonates can result in the formation of mixed asymmetric carbonates, and other carbonate exchanges can take place in principle. The present electrolytes generally do not involve the addition of basic compounds that would be expected to catalyze the base-catalyzed carbonate exchange reactions. However, to the extent that carbonate exchange reactions can take place over the life of the battery, the electrolyte compositions are intended herein to refer to the compositions blended to form the electrolytes without reference to potential subsequent reactions that may take place. Furthermore, evidence presented herein strongly suggests that carbonate exchange does not occur to any significant degree for the present electrolytes under typical battery operating conditions.

With respect to the class of electrolytes based on the first solvent system, the improved electrolytes described herein have three carbonate solvent components. Specifically, the solvent system comprise ethylene carbonate (EC), dimethyl carbonate (DMC), and ethylmethyl carbonate (EMC). The weight percent of ethylmethyl carbonate in the solvent is between about 5 weight percent to about 40 weight percent relative to the total weight of the electrolyte. The weight ratio of ethylene carbonate to dimethyl carbonate can be from about 1:1 to about 1:4. In general, the first class of electrolyte does not comprise more than about 0.5 weight percent non-halogenated carbonates excluding the three explicit carbonates noted above. Small amounts of additional carbonates, e.g., no more than about 0.5 weight percent, can be added or introduced as contaminants without significantly changing the properties, e.g., performance and stability, of the resulting electrolyte. However, for electrolytes based on this first solvent system, organic additives can comprise halogenated carbonates as an additive.

With respect to the second class of electrolytes based on the second solvent system, the electrolytes described herein comprises fluoroethylene carbonate and dimethyl carbonate with a weight ratio of about 1:1 to 1:4. Generally, for these embodiments, the solvent does not comprise any additional linear or cyclic carbonates, except possibly for insignificant amounts. Specifically, the class of electrolytes with the second solvent system does not comprise more than about 0.5 weight percent carbonates excluding the two explicit carbonates noted above. Thus, for electrolytes with the second solvent system, the organic additives exclude any carbonates in excess of 0.5 weight percent.

It has been found that diethyl carbonate does not provide high voltage stability. This is described in published U.S. Patent Application No. 2011/0136019 to Amiruddin et al. (the '019 application), entitled “Lithium Ion Battery with High Voltage Electrolytes and Additives,” incorporated herein by reference. The results presented in the Examples below demonstrate that the electrolytes described herein exhibit excellent high voltage stability over a large number of cycles. This strongly indicates that diethyl carbonate is probably not formed to any significant degree during cycling due to carbonate exchange reactions since the formation of diethyl carbonate from ethylmethyl carbonate would result in high voltage instability that is not observed.

The electrolyte further comprises as a primary lithium salt at least about 1.05M LiPF₆, LiBF₄ or combinations thereof. In addition to the primary lithium salt component, the electrolyte can comprise a lithium salt stabilizing additive. In the electrolytes herein, the lithium salt stabilizing additive generally is any lithium salt in the electrolyte other than LiPF₆ or LiBF₄, although certain classes of lithium salt additives are described that can stabilize the cycling of the batteries without significantly deteriorating the performance properties. In some embodiments, the electrolyte comprise from about 0.01 to about 10 weight percent lithium salt additive.

Also, the electrolyte can comprise a non-ionic organic stabilizing additive, such as N,N-diethylamino trimethylsilane, 2,5-dihydrofuran, ethylmethyl sulfone, fluoroethylene carbonate (FEC, for electrolytes based on the first solvent system), gamma-butyrolactone (GBL), monomer of polyethylene oxide, monomer of polyvinylidine fluoride, and mixtures thereof. The organic additives can have chemical structures with some similarities to organic solvents. As used herein, the first solvent system involves only the three specified components that are present in the ranges of ratios specified herein while the second solvent system involves the two specified components that are present in the ranges of ratios specified herein. Any other non-ionic organic component(s) are considered additives, and the total amount of non-ionic organic additives generally is no more than about 15 weight percent of the electrolyte, except for the specific 0.5 weight percent limits for carbonates as noted above explicitly for the two solvent systems.

### Battery Structure

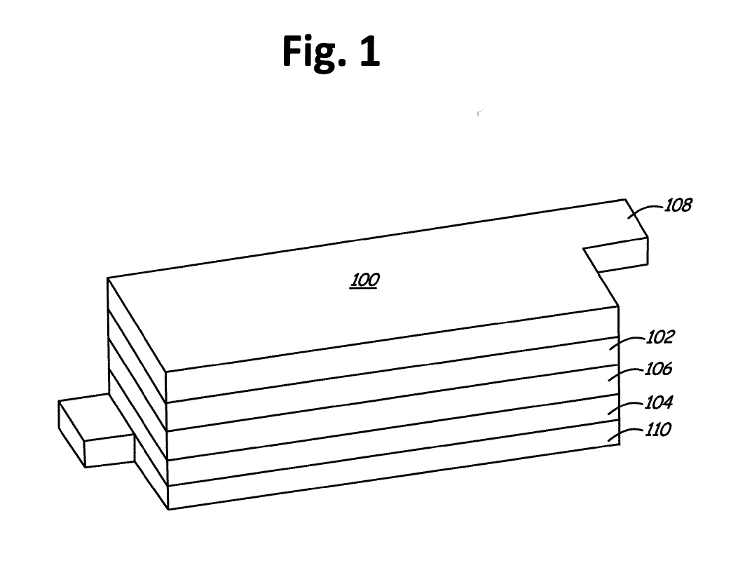

Referring to FIG. 1, a battery 100 is shown schematically having a negative electrode 102, a positive electrode 104 and a separator 106 between negative electrode 102 and positive electrode 104. A battery can comprise multiple positive electrodes and multiple negative electrodes, such as in a stack, with appropriately placed separators. Electrolyte, such as the desirable electrolytes described herein, in contact with the electrodes provides ionic conductivity through the separator between electrodes of opposite polarity. A battery generally comprises current collectors 108, 110 associated respectively with negative electrode 102 and positive electrode 104. The stack of electrodes with their associated current collectors and separator are generally placed within a container with the electrolyte. Electrolytes are described in detail in a subsequent section. In general, the lithium ion battery described herein comprises a positive electrode comprising a lithium intercalation material and a negative electrode comprising a lithium intercalation/alloying material while the lithium battery described herein comprises a positive electrode comprising a lithium intercalation material and a negative electrode comprising elemental lithium or lithium alloy.

The nature of the negative electrode intercalation material influences the resulting voltage of the battery since the voltage is the difference between the half cell potentials at the cathode and anode. Suitable negative electrode lithium intercalation compositions can include, for example, graphite, synthetic graphite, other forms of graphitic carbon, coke, fullerenes, niobium pentoxide, tin alloys, silicon based material, titanium oxide, tin oxide, and lithium titanium oxide, such as LiₓTiO₂, 0.5<x≦1 or Li₁₊ₓTi₂₋ₓO₄, 0≦x≦1/3. Additional negative electrode materials are described in published U.S. Patent Application Nos. 2010/0119942 to Kumar, entitled “Composite Compositions, Negative Electrodes with Composite Compositions and Corresponding Batteries,” and 2009/0305131 to Kumar et al., entitled “Lithium Ion Batteries with Particular Negative Electrode Compositions,” both of which are incorporated herein by reference.

In some embodiments, the negative electrodes can generally comprise elemental carbon materials, e.g., graphite, synthetic graphite, coke, fullerenes, carbon nanotubes, other graphitic carbon and combinations thereof, which are expected to be able to achieve the long term cycling at higher voltages. Graphitic carbon has a low potential so that a resulting battery can operate at a high voltage, e.g., greater than 4.2V, if the cathode active material has a suitable high voltage against lithium metal. Thus, for long cycling applications, high energy density batteries can have negative electrodes with an active elemental carbon material. Graphitic carbon generally comprises graphene sheets of sp² bonded carbon atoms. For convenience, as used herein graphitic carbon refers to any elemental carbon material comprising substantial domains of graphene sheets.

High capacity negative electrode active materials can comprise silicon based material such as elemental silicon and/or silicon oxide (SiOₓ, x<2). In general, these materials exhibit large volume changes during cycling. Recent advances have improved the cycling properties of these high capacity materials, and batteries have been formed that combine high capacity positive electrode active materials and high capacity negative electrode active materials with reasonable cycling behavior. Silicon materials with improved cycling properties is described further in published U.S. Patent Application No. 2011/0111294 to Lopez et al. (the '294 application), entitled “High Capacity Anode Materials for Lithium Ion Batteries,” incorporated herein by reference. High capacity anode materials with improved cycling based on oxygen deficient silicon oxide is described further in copending U.S. patent application Ser. No. 13/108,708 to Deng et al. (the '708 application), now published U.S. patent application 2012/0295155A1, entitled “Silicon Oxide Based High Capacity Anode Materials For Lithium Ion Batteries,” incorporated herein by reference.

For lithium battery, the negative electrode can be, for example, lithium foil, lithium metal powder, lithium metal alloy, or a combination thereof. Commercially available lithium foil can be used directly as negative electrode. While lithium metal such as commercially available stabilized lithium powder can be used with a polymer binder to form the negative electrode, and the discussion herein for the formation of electrodes from other negative electrode powders can be generally applicable to the lithium metal powder. Lithium metal alloys such as lithium aluminum alloy (<4 wt % Al) and lithium magnesium alloy can also be used as negative electrode active material for lithium battery. Lithium aluminum alloy and lithium magnesium alloy in foil format in particular are commercially available.

The positive electrode active compositions and negative electrode active compositions generally are powder compositions that are held together in the respective electrode with a polymer binder. The binder provides ionic conductivity to the active particles when in contact with the electrolyte. Suitable polymer binders include, for example, polyvinylidine fluoride (PVDF), polyethylene oxide, polyimide, polyethylene, polypropylene, polytetrafluoroethylene, polyacrylates, rubbers, e.g. ethylene-propylene-diene monomer (EPDM) rubber or styrene butadiene rubber (SBR), copolymers thereof, or mixtures thereof.

The active particle loading in the binder can be large, such as greater than about 80 weight percent, in further embodiments at least about 83 weight percent and in other embodiments from about 85 to about 97 weight percent active material. A person of ordinary skill in the art will recognize that additional ranges of particles loadings within the explicit ranges above are contemplated and are within the present disclosure. To form the electrode, the powders can be blended with the polymer binder in a suitable liquid, such as a solvent for the polymer binder. The resulting paste can be pressed into the electrode structure.

The positive electrode composition, and in some embodiments the negative electrode composition, generally can also comprise an electrically conductive powder distinct from the electroactive composition. Suitable supplemental electrically conductive powders include, for example, graphite, carbon black, metal powders, such as silver powders, metal fibers, such as stainless steel fibers, and the like, and combinations thereof. Generally, an electrode can comprise from about I weight percent to about 25 weight percent, and in further embodiments from about 2 weight percent to about 20 weight percent and in other embodiments from about 3 weight percent to about 15 weight percent distinct electrically conductive powder. A person of ordinary skill in the art will recognize that additional ranges of amounts of electrically conductive powders within the explicit ranges above are contemplated and are within the present disclosure.

Each electrode generally is associated with an electrically conductive current collector to facilitate the flow of electrons between the electrode and an exterior circuit. A current collector can comprise a metal structure, such as a metal foil or a metal grid. In some embodiments, a current collector can be formed from nickel, aluminum, stainless steel, copper or the like. An electrode material can be cast as a thin film onto a current collector. The electrode material with the current collector can then be dried, for example in an oven, to remove solvent from the electrode. In some embodiments, a dried electrode material in contact with a current collector foil or other structure can be subjected to a pressure from about 2 to about 10 kg/cm² (kilograms per square centimeter).

The separator is located between the positive electrode and the negative electrode. The separator is electrically insulating while providing for at least selected ion conduction between the two electrodes. A variety of materials can be used as separators. Commercial separator materials can be formed from polymers, such as polyethylene and/or polypropylene that are porous sheets that provide for ionic conduction. Commercial polymer separators include, for example, the Celgard® line of separator material from Hoechst Celanese, Charlotte, N.C. Suitable separator materials include, for example, 12 micron to 40 micron thick trilayer polypropylene-polyethylene-polypropylene sheets, such as Celgard® M824, which has a thickness of 12 microns. Also, ceramic-polymer composite materials have been developed for separator applications. These composite separators can be stable at higher temperatures, and the composite materials can significantly reduce the fire risk. The polymer-ceramic composites for separator materials are described further in U.S. Pat. No. 7,351,494 to Hennige et al., entitled “Electric Separator, Method for Producing the Same and the Use Thereof,” incorporated herein by reference. Polymer-ceramic composites for lithium ion battery separators are sold under the trademark Separion® by Evonik Industries, Germany.

Also, on the first cycle of the battery, generally there is an irreversible capacity loss that is significantly greater than per cycle capacity loss at subsequent cycles. The irreversible capacity loss is the difference between the first charge capacity of the new battery and the first discharge capacity. For lithium rich positive electrode active materials, a significant portion of the first cycle irreversible capacity loss can be generally attributed to the positive electrode active material. However, at least some of the irreversible capacity loss can be further attributed to the formation of a solvent electrolyte interphase layer associated with the electrodes, and in particular with the negative electrode. The stable long term cycling of the batteries formed with the electrolytes described herein suggests that the electrolytes are suitable for the formation of stable solvent electrolyte interphase layers.

The electrolytes described herein can be incorporated into various commercial battery designs such as prismatic shaped batteries, wound cylindrical batteries, coin cell batteries, or other reasonable battery shapes. The batteries can comprise a single pair of electrodes or a plurality of pairs of electrodes assembled in parallel and/or series electrical connection(s). While the electrolytes described herein can be used in batteries for primary or single charge use, the resulting batteries generally have desirable cycling properties for secondary battery use over multiple cycling of the batteries.

In some embodiments, the positive electrode and negative electrode can be stacked with the separator between them, and the resulting stacked structure can be rolled into a cylindrical or prismatic configuration to form the battery structure. Appropriate electrically conductive tabs can be welded or the like to the current collectors and the resulting jellyroll structure can be placed into a metal canister or polymer package, with the negative tab and positive tab welded to appropriate external contacts. Electrolyte is added to the canister, and the canister is scaled to complete the battery. Some presently used rechargeable commercial batteries include, for example, the cylindrical 18650 batteries (18 mm in diameter and 65 mm long) and 26700 batteries (26 mm in diameter and 70 mm long), although other battery sizes can be used, as well as prismatic cells and foil pouch batteries of selected sizes.

Pouch cell batteries can be particularly desirable for vehicle applications due to stacking convenience and relatively low container weight. A desirable pouch battery design for vehicle batteries incorporating a high capacity cathode active materials is described in detail in copending U.S. patent application Ser. No. 13/195,672 to Kumar et al. now U.S. Pat. No. 9,083,062, entitled “Battery Packs for Vehicles and High Capacity Pouch Secondary Batteries for Incorporation into Compact Battery Packs,” incorporated herein by reference. While the pouch battery designs are particularly convenient for use in specific battery pack designs, the pouch batteries can be used effectively in other contexts as well with high capacity in a convenient format.

### High Voltage Positive Electrode Active Materials

The low temperature properties of the electrolytes described herein provide desirable operation ranges that can be appropriate for any reasonable lithium ion chemistry. However, the electrolytes particularly provide high voltage stability, so that the electrolytes can be effectively used with high voltage active materials, such as voltages greater than about 4.4 volts and in further embodiments greater than about 4.45V. The battery potentials depend on the half cell potentials of both the anode and the cathode, but higher capacity anode active materials can have a low voltage against lithium for at least a portion of a full discharge cycle.

In general, positive electrode (cathode) active materials of interest comprise a lithium intercalation material such as lithium metal oxides or lithium metal phosphates. Positive electrode active materials include, for example, as stoichiometric layered cathode materials with hexagonal lattice settings like LiCoO₂, LiNiO₂, LiCo_{1/3}Mn_{1/3}Ni_{1/3}O₂ or the like; cubic spinel cathode materials such as LiMn₂O₄, Li₄Mn₅O₁₂, or the like; olivine materials, such as LiMPO₄ (M=Fe, Co, Mn, combinations thereof and the like). Lithium rich positive electrode active materials are of interest due to their high capacity, such as layered cathode materials, e.g., Li₁₊ₓ(NiCoMn)_{0.03-x}O₂ (0≦x<0.3) systems; layer-layer composites, e.g., xLi₂MnO₃.(1−x)LiMO₂ where M can be Ni, Co, Mn, combinations thereof and the like; and composite structures like layered-spinel structures such as LiMn₂O₄.LiMO₂. In some embodiments, a lithium rich composition can be referenced relative to a composition LiMO₂, where M is one or more metals with an average oxidation state of +3.

Generally, the lithium rich compositions can be represented approximately with a formula Li₁₊ₓM_{1-y}O₂, where M represents one or more non-lithium metals and y is related to x based on the average valance of the metals. In some layered-layered composite compositions, x is approximately equal to y. The additional lithium in the initial cathode material can provide to some degree corresponding additional active lithium for cycling that can increase the battery capacity for a given weight of cathode active material. In some embodiments, the additional lithium is accessed at higher voltages such that the initial charge takes place at a higher voltage to access the additional capacity.

Lithium rich positive electrode active materials of particular interest are represented approximately by a formula

Li_{1+b}Ni_{α}Mn_{β}Co_{γ}A_{δ}O_{2-z}F_{z}, Formula I

where b ranges from about 0.05 to about 0.3, α ranges from about 0 to about 0.4, β ranges from about 0.2 to about 0.65, γ ranges from 0 to about 0.46, δ ranges from 0 to about 0.15 and z ranges from 0 to about 0.2 with the proviso that both α and γ are not zero, and where A is a metal element different from Ni, Mn, Co, or a combination thereof. Element A and F (fluorine) are optional cation and anion dopants, respectively. Element A can be, for example Mg, Sr, Ba, Cd, Zn, Al, Ga, B, Zr, Ti, Ca, Ce, Y, Nb, Cr, Fe, V, Li or combinations thereof. A person of ordinary skill in the art will recognize that additional ranges of parameter values within the explicit compositional ranges above are contemplated and are within the present disclosure.

To simplify the following discussion in this section, the optional dopants are not discussed further except for under the context of the following referenced applications. The use of a fluorine dopant in lithium rich metal oxides to achieve improved performance is describe in published U.S. Patent Application No. 2010/0086854 to Kumar et al., entitled “Fluorine Doped Lithium Rich Metal Oxide Positive Electrode Battery Materials With High Specific Capacity and Corresponding Batteries,” incorporated herein by reference. Compositions in which A is lithium as a dopant for substitution for Mn are described in published U.S. Patent Application No. 2011/0052989 to Venkatachalam et al., entitled “Lithium Doped Cathode Material,” incorporated herein by reference. The specific performance properties obtained with +2 metal cation dopants, such as Mg⁺², are described in published U.S. Patent Application No. 2011/0244331 to Karthikeyan et al., entitled “Doped Positive Electrode Active Materials and Lithium Ion Secondary Batteries Constructed Therefrom,” incorporated herein by reference.

The formulas presented herein for the positive electrode active materials are based on the molar quantities of starting materials in the synthesis, which can be accurately determined. With respect to the multiple metal cations, these are generally believed to be quantitatively incorporated into the final material with no known significant pathway resulting in the loss of the metals from the product compositions. Of course, many of the metals have multiple oxidation states, which are related to their activity with respect to the batteries. Due to the presence of the multiple oxidation states and multiple metals, the precise stoichiometry with respect to oxygen generally is only roughly estimated based on the crystal structure, electrochemical performance and proportions of reactant metals, as is conventional in the art. However, based on the crystal structure, the overall stoichiometry with respect to the oxygen is reasonably estimated. All of the protocols discussed in this paragraph and related issues herein are routine in the art and are the long established approaches with respect to these issues in the field.

The stoichiometric selection for the compositions can be based on some presumed relationships of the oxidation states of the metal ions in the composition. As an initial matter, if in Formula I above, b+α+β+γ+δ is approximately equal to 1, then the composition can be correspondingly approximately represented by a two component notation as:

xLi₂M′O₃.(1−x)LiMO₂ Formula II

where 0<x<1, M is one or more metal cations with an average valance of +3 with at least one cation being a Mn ion or a Ni ion and where M′ is one or more metal cations with an average valance of +4. It is believed that the layer-layer composite crystal structure has a structure with the excess lithium supporting the formation of an alternative crystalline phase. For example, in some embodiments of lithium rich materials, a Li₂MnO₃ material may be structurally integrated with either a layered LiMO₂ component where M represents selected non-lithium metal elements or combinations thereof. These compositions are described generally, for example, in U.S. Pat. No. 6,680,143 to Thackeray et al., entitled “Lithium Metal Oxide Electrodes for Lithium Cells and Batteries,” which is incorporated herein by reference.

Recently, it has been found that the performance properties of the positive electrode active materials can be engineered around the specific design of the composition stoichiometry. The positive electrode active materials of particular interest can be represented approximately in two component notation as:

xLi₂MnO₃.(1−x)LiMO₂ Formula III

where M is one or more metal elements with an average valance of +3 and with one of the metal elements being Mn and with another metal element being Ni and/or Co. In general, in Formula II and III above, the x is in the range of 0<x<1, but in some embodiments 0.03≦x≦0.6, in further embodiments 0.075≦x≦0.50, in additional embodiments 0.1≦x≦0.45, and in other embodiments 0.15≦x≦0.425. A person of ordinary skill in the art will recognize that additional ranges within the explicit ranges of parameter x above are contemplated and are within the present disclosure.

In some embodiments, M in Formula III comprises manganese, nickel, cobalt or a combination thereof along with an optional dopant metal and can be written as NiᵤMnᵥCo_{w}A_{y}, where A is a metal other than Ni, Mn or Co. Consequently Formula III now becomes:

x.Li₂MnO₃.(1−x)LiNiᵤMnᵥCo_{w}A_{y}O₂ Formula IV

where u+v+w+y≈1. While Mn, Co and Ni have multiple accessible oxidation states, which directly relates to their use in the active material, in these composite materials if appropriate amounts of these elements are present, it is thought that the elements can have the oxidation states Mn⁺⁴, Co⁺³ and Ni⁺². In the overall formula, the total amount of manganese has contributions from both constituents listed in the two component notation. Additionally, if δ=0 in Formula I, the two component notation of Formula IV can simplify with v≈u to x.Li₂MnO₃.(1−x)LiNiᵤMnᵤCo_{w}O₂, with 2u+w=1.

In some embodiments, the stoichiometric selection of the metal elements can be based on the above presumed oxidation states. Based on the oxidation state of dopant element A, corresponding modifications of the formula can be made. Also, compositions can be considered in which the composition varies around the stoichiometry with v≈u. The engineering of the composition to obtain desired battery performance properties is described further in published U.S. Patent Application No. 2011/0052981 (the '981 application) to Lopez et al., entitled “Layer-Layer Lithium Rich Complex Metal Oxides With High Specific Capacity and Excellent Cycling,” incorporated herein by reference. Similar compositions have been described in published U.S. Patent Application No. 2010/0086853A (the '853 application) to Venkatachalam et al. entitled “Positive Electrode Material for Lithium Ion Batteries Having a High Specific Discharge Capacity and Processes for the Synthesis of these Materials”, and published U.S. Patent Application No. 2010/0151332A (the '332 application) to Lopez et al. entitled “Positive Electrode Materials for High Discharge Capacity Lithium Ion Batteries”, both incorporated herein by reference.

The positive electrode material can be advantageously synthesized by co-precipitation and sol-gel processes detailed in the '853 application and the '332 application. In some embodiments, the positive electrode material is synthesized by precipitating a mixed metal hydroxide or carbonate composition from a solution comprising +2 cations wherein the hydroxide or carbonate composition has a selected composition. The metal hydroxide or carbonate precipitates are then subjected to one or more heat treatments to form a crystalline layered lithium metal oxide composition. A carbonate co-precipitation process described in the '332 application gave desired lithium rich metal oxide materials having cobalt in the composition and exhibiting the high specific capacity performance with superior tap density. These copending patent applications also describe the effective use of metal fluoride coatings to improve performance and cycling.

It is found that for many positive electrode active materials a coating on the material can improve the performance of the resulting batteries. Suitable coating materials, which are generally believed to be electrochemically inert during battery cycling, can comprise metal fluorides, metal oxides, metal non-fluoride halides or metal phosphates. In some embodiments, the materials can comprise a coating with a thickness from about 0.5 nanometers (nm) to about 30 nm.

For example, the general use of metal fluoride compositions as coatings for cathode active materials, specifically LiCoO₂ and LiMn₂O₄, is described in published PCT Application No. WO 2006/109930A to Sun et al., entitled “Cathode Active Material Coated with Fluorine Compound for Lithium Secondary Batteries and Method for Preparing the Same,” incorporated herein by reference. Improved metal fluoride coatings with appropriately engineered thicknesses are described in published U.S. Patent Application No. 2011/0111298 to Lopez et al, (the '298 application) entitled “Coated Positive Electrode Materials for Lithium Ion Batteries,” incorporated herein by reference. Suitable metal oxide coatings are described further, for example, in published U.S. Patent Application No. 2011/0076556 to Karthikeyan et al. entitled “Metal Oxide Coated Positive Electrode Materials for Lithium-Based Batteries”, incorporated herein by reference. The discovery of non-fluoride metal halides as desirable coatings for cathode active materials is described in copending U.S. patent application Ser. No. 12/888,131, now U.S. Pat. No. 8,663,849B2 to Venkatachalam et al., entitled “Metal Halide Coatings on Lithium Ion Battery Positive Electrode Materials and Corresponding Batteries,” incorporated herein by reference. The synthesis approaches along with the coating provide for superior performance of the materials with respect to capacity as well as cycling properties. The desirable properties of the active material along with the use of desirable electrolytes provide for the improved battery performance described herein.

### Electrolyte

The electrolyte provides for ion transport between the anode and cathode of the battery during the charge and discharge processes. To stabilize high voltage operation, the solvent is selected to provide stability with respect to avoidance of oxidation of the electrolyte as well as an appropriate additive to stabilize the cycling. The electrolytes described herein are designed for effective operation over a large temperature range. The electrolytes generally comprise an organic non-aqueous solvent, a primary lithium salt, a lithium salt additive and an optional organic stabilizing additive. Two specific solvent systems are described herein with specific solvent combinations, and organic compounds other than the compositions in the particular solvent combination are considered organic additives for these solvent systems regardless if the organic compounds have solvent like properties. In general, the electrolyte can comprise compositions within four classes of electrolyte components that are solvent, primary lithium salt, lithium salt additive and optional organic stabilizing additive. In some embodiments, the electrolytes are stable at high voltages, e.g., above 4.4 V. In additional or alternative embodiments, the electrolytes can support high rates of discharge. The electrolytes in general are stable through a long range of cycle numbers, for example from hundreds to thousands of cycles.

The solvent of the electrolyte generally comprises a blend of organic compositions, and two solvent systems are described. With respect to improved electrolytes described herein based on a first solvent system, the solvents comprise a blend of ethylene carbonate, dimethyl carbonate, and ethylmethyl carbonate. With respect to electrolytes based on a second solvent system, the solvents comprise a blend of fluoroethylene carbonate and dimethyl carbonate. As used herein including in the claims, any additional organic compositions in the electrolyte beyond the base explicit carbonate blends are considered organic additives even if they could be characterized in some sense as solvents. Similarly, the primary lithium salt is LiPF₆, LiBF₄, or combinations thereof. The electrolyte generally also comprises a lithium salt additive. The lithium salt additive further contributes lithium cations to the electrolyte similar to the lithium base salt, but the lithium salt additives are considered as distinct components of the electrolyte. The electrolyte is generally non-aqueous, and water can be considered an undesirable contaminant that can degrade battery components. Of course, trace amounts of water may be present, although processing is generally performed to keep the amount of water contamination very low.

Additives have been found to be successful at stabilizing the cycling properties of high voltage lithium ion batteries, e.g., batteries with lithium rich positive electrode active compositions described herein. As noted above, some of the additives can comprise a lithium salt while other additives are organic compositions. Some of the organic additive compositions have chemical compositions similar to suitable solvent compositions. In particular, the selection of the solvent and the electrolyte salt along with the inclusion of one or more additives can improve the cycling stability. As described herein, the selection of electrolyte additives can be combined with the inclusion of electroactive materials with excellent properties with respect to energy density and other capacity parameters as well as cycling to result in remarkable performance properties. In particular, the electrolyte should be stable both with respect to resisting chemical changes over the passage of time as well as resisting chemical degradation as a result of the electrochemical reactions in the cell. Furthermore, desirable additives can further stabilize the electroactive materials during cycling.

Solvent

Two distinct solvent systems are described herein that can provide desirable low temperature performance out to a large number of cycles. A first solvent system is based on a ternary solvent comprising three carbonate solvents and a second binary solvent system with one fluorinated solvent component. As used herein, if the electrolyte comprises any carbonate compositions besides the explicit primary solvents of the particular solvent system, these additional compositions are considered organic additives in the electrolyte with the corresponding quantity limits. In a first solvent system the primary solvent component of the electrolyte is a tertiary blend of ethylene carbonate (EC), dimethyl carbonate (DMC), and ethylmethyl carbonate (EMC). in a second solvent system, the solvent component of the electrolyte is a blend of fluoroethylene carbonate (FEC) and dimethyl carbonate (DMC). The solvent blends are generally a viscous liquid at room temperature. The relative amounts of the solvent components can be selected to balance the various properties introduced by the particular solvent components. In general, the additional components of the electrolyte have particular ranges of their quantities in the electrolyte. Thus, once all of the components are accounted for in the electrolyte, the electrolyte accordingly comprises a significant quantity of the primary solvent blend. Specific solvent blends are described in the following with surprisingly good performance characteristics with respect to low temperature behavior as well as cycling out to large numbers of cycles. In the solvent systems herein, the solvent is generally substantially free of diethyl carbonate (DEC) due to high voltage instability that has been observed for DEC.

With respect to the first solvent system, ethylene carbonate has a boiling point of about 248° C. and a melting point of about 39-40° C. and therefore is a solid at room temperature. To produce an electrolyte solvent combination that is a liquid at room temperature, low melting point solvents DMC and EMC can be included in the solvent blend to form a solvent blend that is a liquid at room temperature. Dimethyl carbonate has a boiling point of 91° C. and melting point of 4.6° C. and therefore is a volatile liquid at room temperature. Ethylmethyl carbonate has a boiling point of 107° C. and a melting point of −55° C.

Plichta et al. disclosed in Journal of Power Sources 88(2000) 192-196 a ternary electrolyte solvent system that comprises the volume ratios 1:1:1 (v:v:v) EC-DMC-EMC and 1M LiPF₆. The solvents systems described herein provide surprisingly improved performance with different quantities of the solvent components. Also, lithium salt additives are also advantageously included in the electrolytes described herein. The resulting electrolytes provide superior low temperature and long cycling performances. The quantities of dimethyl carbonate solvent components for example is referenced to the weight of ethylene carbonate as a convenient reference point. EC, DMC, and EMC have different molecular weight and density as outlined in table I below. Because DMC and EMC have comparable densities that are significantly less than the density of EC, the volume ratio of 1:1:1 (v:v:v) EC-DMC-EMC when converted to weight ratio becomes approximately 1:0.81:0.76 (wt:wt:wt) EC-DMC-EMC. The system disclosed in Plichta above, therefore contains less DMC in a weight ratio than EC.

TABLE 1

| | MW (g/mol) | D (g/mL) | m.p. ° C. |
|---|---|---|---|
| EC | 88.06 | 1.321 | 34-37 |
| DMC | 90.08 | 1.071 | 2-4 |
| EMC | 104.11 | 1.01 | −55 |

Specifically, in embodiments of the first solvent system herein, the electrolyte principle solvent comprises a weight ratio of ethylene carbonate to dimethyl carbonate from about 1:1 to about 1:4, in further embodiments from about 1:1.25 to about 1:3, in additional embodiments from about 1:1.5 to about 1:2.5, and in other embodiments from about 1:1.75 to about 1:2.25. A person of ordinary skill in the art will recognize that additional ranges of values within the explicit ratio ranges above are contemplated and are within the present disclosure.

The quantity of the ethyl methyl carbonate can be expressed as the weight percent of the total electrolyte weight. In other words, the weight percent of ethyl methyl carbonate is equal to [100×W_{EMC}/(W_{EC}+W_{DMC}+W_{EMC}+W_{primary litium salt}+W_{lithium salt additive}+Wₒₜₕₑᵣ)], where W_{EC} is the weight of ethylene carbonate, W_{DMC} is the weight of dimethyl carbonate, W_{EMC} is the weight of ethylmethyl carbonate, W_{primary lithium salt} is the total weight of the primary lithium salt, W_{lithium salt additive} is the total weight of the lithium salt additives, and Wₒₜₕₑᵣ is the weight of optional organic additives in the electrolyte. In particular, the electrolyte comprises a weight percent of ethylmethyl carbonate from about 5 weight percent to about 40 weight percent, in further embodiments from about 8 weight percent to about 37.5 weight percent, in additional embodiments from about 10 weight percent to about 35 weight percent, and in other embodiments from about 15 weight percent to about 32 weight percent. A person of ordinary skill in the art will recognize that additional ranges of values within the explicit weight percent ranges above are contemplated and are within the present disclosure.

The solvents have been implicated in the formation of solid electrolyte interphase (SEI) layer, which forms on the first charge of the battery and can contribute to the cycling stability of the battery through the decrease of subsequent reaction of the electrolyte, e.g., oxidation of the electrolyte. In particular, ethylene carbonate can be desirable for relatively stabile SEI layer formation. As noted herein, the solvents described herein provide for excellent cycling properties, which implies that a stable SEI layer is formed. For high voltage operation, another significant aspect of the electrolyte properties is the oxidative stability. The oxidative stability can depend on both the solvent and the lithium salt. Suitable combinations of solvent and lithium salts can be used for high voltage operation, i.e., voltages above 4.45 volts. The improved oxidative stability is shown to improve cycling performance of the corresponding batteries.

With respect to the second solvent system described herein, fluorinated carbonates such as fluoroethylene carbonate (FEC) (C₃H₃FO₃) has been used to improve the safety of batteries due to its non-flammability. Published U.S. Patent Application No. 2011/0165474 to Im et al., entitled: “Electrolyte for a high voltage battery and lithium secondary battery comprising the same”, incorporated herein by reference, for example, used fluoroethylene carbonate compound and a linear ester compound as solvent for electrolyte to produce batteries that are stable at 150° C. Incorporation of FEC into solvent blends for electrolytes different from the solvent combinations described herein are described in R. McMillan, H. Slegr, Z. X. Shu, and W. Wang, J. Power Sources, 81, 20 (1999); N.-S. Choi, K. H. Yew, K. Y. Lee, M. Sung, H. Kim, and S.-S. Kim, J. Power Sources, 161, 1254 (2006); I. A. Profatilova, S.-S. Kim, and N.-S. Choi, Electrochim. Acta, 54, 4445 (2009); and T. Achiha, T. Nakajima, Y. Ohzawa, M. Koh, A. Yamauchi, M. Kagawa, and H. Aoyama, J. Electrochem. Soc., 156, A483 (2009), all incorporated herein by reference. The FEC/DMC combination described herein, however, has shown improvements of cycling capacity and superior low temperature performance.

In some embodiments, for the second solvent system the electrolyte principle solvent comprises a weight ratio of fluoroethylene carbonate to dimethyl carbonate from about 1:1 to about 1:4, in further embodiments from about 1:1.25 to about 1:3, in additional embodiments from about 1:1.5 to about 1:2.5, and in other embodiments from about 1:1.75 to about 1:2.25. A person of ordinary skill in the art will recognize that additional ranges of values within the explicit ratio ranges above are contemplated and are within the present disclosure.

Lithium Salt (Primary Lithium Salt Plus Lithium Additive Salt)

The primary lithium salt provides lithium ions to support battery cycling. The selection of the particular primary lithium salt can be based on appropriate solubility, ion mobility and stability. The lithium salt dissolves into the non-aqueous solvents specified herein. The particular electrolyte salt(s) and their concentration in the electrolyte can influence the oxidative stability of the resulting electrolyte. Additives generally can be classified either as lithium salts or as organic additives, although the lithium salts can have an organic anion. Lithium ions in the electrolyte are contributed by both the primary lithium salt and the lithium salt additive.

The primary lithium salt in general comprises LiPF₆, LiBF₄ or combinations thereof. In some embodiments, the electrolytes described herein comprises from about 1.05M to about 2.0M primary lithium salt and one or more lithium salt additives in a total amount from about 0.01 weight percent to about 10 weight percent of the total weight of the electrolyte. In additional or alternative embodiments, the concentration of the primary lithium salt in the electrolyte is from about 1.05M to about 1.9M, in further embodiments from about 1.05M to about 1.8M, in additional embodiments from about 1.1M to about 1.75M, and in other embodiments from about 1.15M to about 1.6M. With respect to the lithium salt additives, the electrolyte can comprise in some embodiments from about 0.05 weight percent to about 9 weight percent, in other embodiments from about 0.1 weight percent to about 8 weight percent and in further embodiments from about 0.25 weight percent to about 7.5 weight percent of the total electrolyte weight. A person of ordinary skill in the art will recognize that additional ranges of values within the explicit salt concentration ranges above are contemplated and are within the present disclosure.

A class of alternative electrolyte salts suitable for use as electrolyte salt additives as described herein is described in U.S. Pat. No. 6,783,896 to Tsujioka et al. (“the '896 patent”), entitled “Electrolyte for Electrochemical Device,” incorporated herein by reference. In particular, the alternative electrolytes in the '896 patent are ionic complexes formed as lithium salts for the formation of a lithium-based electrolyte with a formula representation as follows:

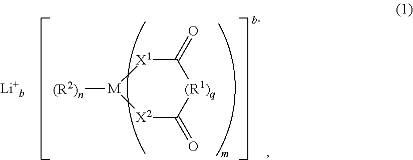

where b is a number from 1 to 3, m is a number from 1 to 4, n is a number from 1 to 8, q is 0 or 1, M can be a transition metal or an element from groups 13, 14 or 15 of the periodic table, in particular aluminum, boron, phosphorous, arsenic, antimony or silicon, R¹ is optional and can be an organic group, R² is a halogen atom or an organic group, X¹ and X² are independently O, S or NR⁴, and R⁴ is a halogen atom or an organic group. In general, R¹ can be C₁-C₁₀ alkylene group, C₄-C₂₀ arylene group, halogenated forms of these groups, optionally with other substituents and/or heteroatoms and/or rings. R² can independently be a halogen atom, a C₁-C₁₀ alkyl group, a C₄-C₂₀ arylene group, halogenated forms of these groups, optionally with other substituents and/or heteroatoms and/or rings. If R² are organic groups, a plurality of R² groups can form bonds with each other to form a ring. In some embodiments of interest, R¹ is absent such that the overall group linked by R¹ reduces to an oxalato group (—C₂O₂—). Compositions of particular interest are represented by formulas where the R² groups are halogen atoms, e.g., F, and X¹ and X² are O atoms. The '896 patent exemplified LiBF₂C₂O₄ (lithium difluoro(oxalato)borate as an electrolyte or in an electrolyte blend.

Other lithium salts with anions based on complexes are described further in U.S. Pat. No. 6,787,267 to Tsujioka et al. (the '267 patent), entitled “Electrolyte for Electrochemical Device,” incorporated herein by reference. The '267 patent describes electrolytes represented by a formula:

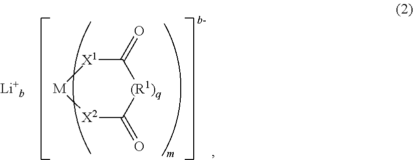

The same notation is used for moieties in formula (2) as is used for formula (1) above. One compound of interest within this genus is LiB(C₂O₄)₂, i.e. lithium bis(oxalato)borate. The combination of lithium bis(oxalato)borate with a solvent comprising a lactone is described further in U.S. Pat. No. 6,787,268 to Koike et al., entitled “Electrolyte,” incorporated herein by reference. Furthermore, additives comprising lithium salts with heteroborate cluster anions are described in published U.S. Patent Application No. 2008/0026297 to Chen et al., entitled “Electrolytes, Cells and Methods of Forming Passivation Layers,” incorporated herein reference.

Electrolyte salts based on lithium salts represented with the formula Li₂B₁₂FₓZ₁₂₋ₓ have been proposed, where Z is hydrogen, chlorine or bromine atoms. For variations with at least 3 halogen atoms, see U.S. Pat. No. 7,465,517 to Ivanov et al., entitled “High Purity Lithium Polyhalogenated Boron Cluster Salts Useful in Lithium Batteries,” incorporated herein by reference. For x between 4 and 12, see U.S. Pat. No. 7,348,103 to Ivanov et al., entitled “Polyfluoronated Boron Cluster Anions for Lithium Electrolytes,” incorporated herein by reference. Of particular interest are the version represent by the formula Li₂B₁₂HₓF₁₂₋ₓ(x=0-3) (lithium fluorododecaborate). Also, lithium (bis)trifluoromethane sulfonimide (LiN(CF₃SO₂)₂), lithium pentafluoroethane sulfonimide (LiN(C₂F₅SO₂)₂) and lithium trifluoromethane sulfonmethide (LiC(CF₃SO₂)₃) have been proposed as suitable electrolyte salts, and these can be desirably used as additives in the present electrolytes with lithium (bis)trifluoromethane sulfonimide being of particular interest. For a further description of these sulfonimide/sulfonimethimide electrolyte salts, see U.S. Pat. No. 6,482,549 to Yoshimura et al., entitled “Rechargeable Lithium Battery,” incorporated herein by reference.

In summary, various useful lithium salt additives are described above, and particularly suitable lithium salt additives of the electrolyte described herein include lithium difluoro oxalato borate (LiDFOB), lithium bis(oxalato)borate (LiBOB), lithium fluorododecaborate (Li₂B₁₂HₓF₁₂₋ₓ(x=0-3)), lithium (bis)trifluoromethane sulfonimide, or a combination thereof. Additives have been found that improve the cycling performance of the high voltage batteries. In general, the function of the additives may or may not be well understood. In some embodiments, the additives may be effective to prevent side reactions that result in undesired irreversible changes to the battery materials. For example, undesirable reaction can involve the solvent electrolyte or the active materials in the electrode. Through the decrease in the irreversible side reactions, the cycling performance of the battery can be correspondingly improved.

Organic Additives

As noted above, the electrolyte can also comprise an organic additive to stabilize cycling. Some additives are potentially suitable as solvents, but beneficial effects of the compositions are observed at additive concentrations. For example, one class of additives relate to carbonates. Carbonates have a structure R—OCOO—R′, with selected substituents R and R′.

Gamma-butyrolactone is thought to be a suitable solvent for high voltage lithium ion secondary batteries. Substituted gamma-butyrolactones are suitable additives to reduce reactions at the negative electrode during cycling through the formation of a stable film. Suitable additive compositions include, for example, fluoro γ-butyrolactone, difluoro γ-butyrolactone, chloro γ-butyrolactone, dichloro γ-butyrolactone, bromo γ-butyrolactone, dibromo γ-butyrolactone, nitro γ-butyrolactone, cyano γ-butyrolactone, and combinations thereof. These additives are discussed further in U.S. Pat. No. 7,491,471 to Yamaguchi et al., entitled “Electrolyte for Lithium Secondary Battery and Lithium Secondary Battery Comprising the Same,” incorporated herein by reference.

Another group of additives comprise monomers that are capable for undergoing anionic polymerization. During the formation of the battery, a protective film can form on the negative electrode active materials. Suitable monomers can include, for example, isoprene, styrene, 2-vinylpyridine, 1-vinylimidazole, butyl acrylate, ethyl acrylate, methyl methacrylate, N-vinylpyrrolidone, ethyl cinnamate, methyl cinnamate, ionone and myrcene. The use of these monomers as battery additives is described further in U.S. Pat. No. 6,291,107 to Shimizu, entitled “Non-Aqueous Electrolyte Battery,” incorporated herein by reference.

Nitrogen containing heterocyclic compounds have been identified as additives for improving high temperature storage characteristics as well as for forming SEI layers. Among other suitable additives, pyrrolidine compounds have been identified, including, for example, 1-alkyl (or alkenyl)pyrrolidone compounds, such as 1-methyl-2-pyrrolidone, 1-ethyl-2-pyrrolidone, 1-vinyl-2-pyrrolidone, 1,5-dimethyl-2-pyrrolidone, 1-isopropyl-2-pyrrolidone, 1-n-butyl-2-pyrrolidone, 1-methyl-3-pyrrolidone, 1-ethyl-3-pyrrolidone, and 1-vinyl-3-pyrrolidone; 1-arylpyrolidone compounds, such as 1-phenyl-2-pyrrolidone and 1-phenyl-3-pyrrolidone; N-alkylsuccinimide compounds, such as N-methylsuccinimide, N-ethylsuccinimide, N-cyclohexylsuccinimide and N-isobutylsuccinimide; N-alkenylsuccinimide compounds, such as N-vinylsuccinimide; and N-(hetero)arylsuccinimide compounds such as N-phenylsuccinimide, N-(p-tolyl)succinimide, and N-(3-pyridyl-)succinimide. The use of these heterocyclic compounds along with other additive options is described further in published U.S. Patent Application No. 2003/0165733 to Takehara et al., entitled “Nonaqueous Electrolyte Solution and Secondary Battery Employing the Same,” incorporated herein by reference. Heterocyclic additives including derivatives of succinimide, phthalimide and maleimide are described in published U.S. Patent Application No. 2006/0172201 to Yasukawa et al., entitled “Non-Aqueous Electrolyte and Lithium Secondary Battery Using the Same,” incorporated herein by reference. Imide stabilizing compounds for lithium metal secondary batteries include N-hydroxy phthalimide, N-hydroxysuccinimide, N,N-disuccinimidyl carbonate, 1,5-bis(succinimidoxycarbonyloxy)pentane, 9-fluorenylmethyl-N-succinimidyl carbonate, N-(benzyloxycarbonyloxy)succinimide and Z-glycine-N-succinimidyl ester, as described in U.S. Pat. No. 6,645,671 to Tsutsumi et al., entitled “Lithium Secondary Battery, Anode for Lithium Secondary Battery, and Method for Manufacturing the Anode,” incorporated herein by reference.

Electrolyte additives for stabilizing cells based on spirocyclic hydrocarbons are described in U.S. Pat. No. 7,507,503 to Amine et al. (“the '503 patent”), entitled “Long Life Lithium Batteries with Stabilized Electrodes,” incorporated herein by reference. The hydrocarbons contain at least one oxygen atom and at least one alkenyl or alkynyl group. The spirocyclic additives of particular interest include compositions represented by the formula:

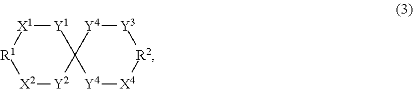

where X¹, X², X³ and X⁴ are independently O or CR³R⁴, provided that X¹ is not O when Y¹ is O, X² is not O when Y² is O, X³ is not O when Y³ is O and X⁴ is not O when Y⁴ is O; Y¹, Y², Y³, and Y⁴ are independently O or CR³R⁴; R¹ and R² are independently a substituted or unsubstituted divalent alkenyl or alkynyl group; and R³ and R⁴ are independently H, F, Cl, or an unsubstituted alkyl, alkenyl or alkynyl group. The '503 patent described the use of their additives with various lithium salts including, for example, conventional lithium salts.

Halogenated carbonate additives to the electrolytes can further provide performance improvements with respect to the cycling stability. Suitable halogenated carbonates include, for example, fluoroethylene carbonate (C₃H₃FO₃), fluorinated vinyl carbonate, monochloro ethylene carbonate, monobromo ethylene carbonate, 4-(2,2,3,3-tetrafluoropropoxymethyl)-[1,3]dioxolan-2-one, 4-(2,3,3,3-tetrafluoro-2-trifluoro methyl-propyl)-[1,3]dioxolan-2-one, 4-trifluoromethyl-1,3-dioxolan-2-one, bis(2,2,3,3-tetrafluoro-propyl) carbonate, bis(2,2,3,3,3-pentafluoro-propyl) carbonate, mixtures thereof and the like. Note that ethylene carbonate is also known by its IUPAC name of 1,3-dioxolan-2-one. The effectiveness of halogenated carbonate additives for silicon oxide based lithium ion batteries is described further in the '708 application noted above. Halogenated carbonates are suitable organic additives for the first solvent system described herein based on the EC, DMC and EMC blend, while the second solvent system with the blend of FEC and DMC in general comprises no more than about 0.5 weight percent carbonates, including additional halogenated carbonates, besides FEC and DMC.

In some embodiments, the weight percent of the organic additive in the electrolyte is from about 0.0005 weight percent to about 15 weight percent, in further embodiments from about 0.01 weight percent to about 10 weight percent, in additional embodiments from about 0.05 weight percent to about 5 weight percent, and in other embodiments from about 0.1 weight percent to about 3 weight percent. A person of ordinary skill in the art will recognize that additional ranges of values within the explicit weight percent ranges above are contemplated and are within the present disclosure.

Battery Performance with Low Temperature Electrolytes

Batteries formed with electrolytes described herein can provide superior performance at high voltage operation over a wide temperature range and relatively high charge/discharge rates. The batteries with the temperature stable electrolytes can also exhibit excellent cycling properties over a large number of cycles, which indicates good stability of the electrolyte. With respect to rate, the notation C/x implies that the battery is charge (discharged) at a rate to fully charge (discharge) the battery to the selected voltage minimum in x hours. In general, the batteries are charged to 4.6V in the first cycle at a rate low rate, such as C/10. For additional cycling a different charge voltage can be selected, and performance values below are referenced to selected charge voltages. A desirable multistep formation protocol can be used, as described further in published U.S. Patent Application No. 2011/0236751 to Amiruddin et al., entitled “High Voltage Battery Formation Protocols and Control of Charging and Discharging For Desirable Long Term Cycling Performance,” incorporated herein by reference.

In general, batteries using the electrolytes described herein can have a discharge capacity at −30 degrees Celsius that is at least about 20% of the room temperature (25° C.) discharge capacity, in further embodiments at least about 25%, in additional embodiments at least about 30% and in other embodiments from about 35% to about 50% of the room temperature discharge capacity when discharged from 4.5V to 2V at a rate of C/10. Specifically, the batteries can have a specific capacity of at least about 50 mAh/g, in further embodiments at least about 55 mAh/g and in additional embodiments from about 60 mAh/g to about 130 mAh/g relative to the weight of the positive electrode active material when discharged at −30° C. from 4.5V to 2 V at a rate of C/10. A person of ordinary skill in the art will recognize that additional ranges of values within the explicit specific capacity ranges above are contemplated and are within the present disclosure.

In some embodiments, batteries using the electrolytes described herein can have a discharge capacity at −40 degrees Celsius that is at least about 10% of the room temperature discharge capacity, in further embodiments at least about 12.5% and in other embodiments from about 15% to about 25% of the room temperature discharge capacity when discharged from 4.5V to 2V at C/10. Specifically, the batteries can have a specific capacity of at least about 20 mAh/g, in further embodiments from at least about 30 mAh/g and in additional embodiments from about 35 to about 60 mAh/g relative to the weight of the positive electrode active material when discharged at −40° C. from 4.5V to 2 V at a rate of C/10. A person of ordinary skill in the art will recognize that additional ranges of values within the explicit percent ranges above are contemplated and are within the present disclosure.

In general, batteries using the electrolytes described herein can maintain good cycling stability at high temperatures out to large number of cycles. For example, the batteries cycled at 45° C. in the voltage window of 4.35V to 2.2 V at a rate of 1 C charge and 1 C discharge can retain at least about 60% capacity out to 1500 cycles, in some embodiment at least about 65% capacity, in further embodiment at least about 70% capacity, and in additional embodiment from about 55% to about 75% capacity relative to the fifth cycle capacity. A person of ordinary skill in the art will recognize that additional ranges of values within the explicit specific percentage ranges above are contemplated and are within the present disclosure.

In addition, batteries constructed with the electrolytes described herein can maintain good cycling performance at high charge/discharge rates. The batteries in general can maintain at least about 105 mAh/g, in further embodiments at least about 115 mAh/g, in other embodiments at least about 120 mAh/g, and in additional embodiments from about 125 mAh/g to about 160 mAh/g specific discharge capacity based on the weight of the positive electrode active material when discharged from 4.5V to 2.0V at a discharge rate of 5 C. The batteries in general can maintain at least about 45%, in further embodiments at least about 50% and in other embodiments from about 55% to about 65% of its specific discharge capacity when discharged from 4.5V to 2.0V at the discharge rate of 5 C compared to the specific discharge capacity at C/3. Similarly, the batteries in general can maintain at least about 30 mAh/g, in further embodiments at least about 40 mAh/g, in other embodiments at least about 60 mAh/g, in additional embodiments from about 70 mAh/g to about 110 mAh/g, and in still further embodiments from about 80 mAh/g to about 95 mAh/g specific discharge capacity based on the weight of the positive electrode active material when discharged from 4.5V to 2.0V at a discharge rate of 10 C. The batteries in general can maintain at least about 10%, in further embodiments at least about 15%, in other embodiments from about 20% to about 45%, and in additional embodiments from about 25% to about 40% of its specific discharge capacity when discharged from 4.5V to 2.0V at the discharge rate of 10 C compared to the specific discharge capacity at C/3. A person of ordinary skill in the art will recognize that additional ranges of values within the explicit ranges of specific capacity and percentages of specific capacity at 5 C above are contemplated and are within the present disclosure.

While the batteries described herein are designed for operation over a broad range of temperatures, the batteries with the electrolyte having good temperature range tolerance maintain good room temperature cycling properties. The batteries constructed with the electrolytes described herein can maintain good cycling capacity out to several thousands of cycles under high voltage and at reasonable charge/discharge rates. In particular, the batteries with the temperature tolerant electrolyte can be cycles to 1000 charge/discharge cycles from 4.5V to 2V at a rate of C/3 while maintaining at least about 60% of their discharge capacity, in further embodiments at least about 65% and in additional embodiments at least about 70% of the 5th cycle capacity at room temperature. With respect to higher rate performance, the batteries with the temperature tolerant electrolytes can be cycled out to 200 charge/discharge cycles while maintaining at least about 90 mAh/g, in further embodiments at least about 100 mAh/g and in other embodiments at least about 105 mAh/g specific discharge capacity based on the weight of the positive electrode active material when charged at a rate of 1 C and discharged at a rate of 2 C from 4.5V to 2.0V at room temperature. A person of ordinary skill in the art will recognize that additional ranges of values within the explicit ranges specific capacity and specific capacity percentages above are contemplated and are within the present disclosure.

It has been discovered that the lithium rich metal oxides described above can be stably cycled for a very large number of cycles at a significant fraction of the available capacity using an appropriately selected voltage window. In particular, the battery design is informed through an understanding of qualitative changes that can take place with respect to the active material when cycling. Thus, the active material can be cycled to obtain significant portions of the capacity without unnecessarily destabilizing the active material. This improved cycling performance is described further in copending U.S. patent application Ser. No. 13/213,756 (the '756 application), now U.S. Pat. No. 8,928,286B2 to Amiruddin et al, entitled “Very Long Cycling of Lithium Ion Batteries With Lithium Rich Cathode Materials,” incorporated herein by reference. In the '756 application, the positive electrode active material can be initially activated to a voltage of 4.6V or other selected value or gradually activated during cycling through the appropriate selection of the charge voltage. For batteries using the electrolytes described herein, when cycled over 2000 charge/discharge cycles with a charge rate of 1 C and discharge rate of 2 C over a voltage range of 4.24V to 2.73V, the batteries in general can maintain at least about 70% of the discharge capacity, in further embodiments at least about 72.5% and in other embodiments at least about 75% of the 5th cycle discharge capacity. A person of ordinary skill in the art will recognize that additional ranges of values within the explicit ranges of capacity percentages at conditions above are contemplated and are within the present disclosure.

### EXAMPLES

### Example 1

### High Voltage Electrolyte with Different Solvent Ratios

Electrolyte samples 1 to 5 with different solvent ratio as shown in Table 2 were formulated and tested for performances under various conditions including low and high temperatures.

Conductivity Studies

TABLE

| | LiPF₆ | EC:DMC:EMC | LiDFOB | EMC | Conductivity |
|---|---|---|---|---|---|
| Electrolyte | (M) | (Wt Ratio) | (wt %) | (wt %) | (mS/cm) |
| Sample 1 | 1.5 | 1:2 | 0 | 0 | 9.5 |
| Sample 2 | 1.5 | 1:2 | 3 | 0 | 8.3 |
| Sample 3 | 1.32 | 1:2:0.37 | 2.73 | 10 | 8.3 |
| Sample 4 | 1.17 | 1:2:0.74 | 2.5 | 20 | 8.4 |
| Sample 5 | 1.06 | 1:2:1.11 | 2.31 | 30 | 8.3 |

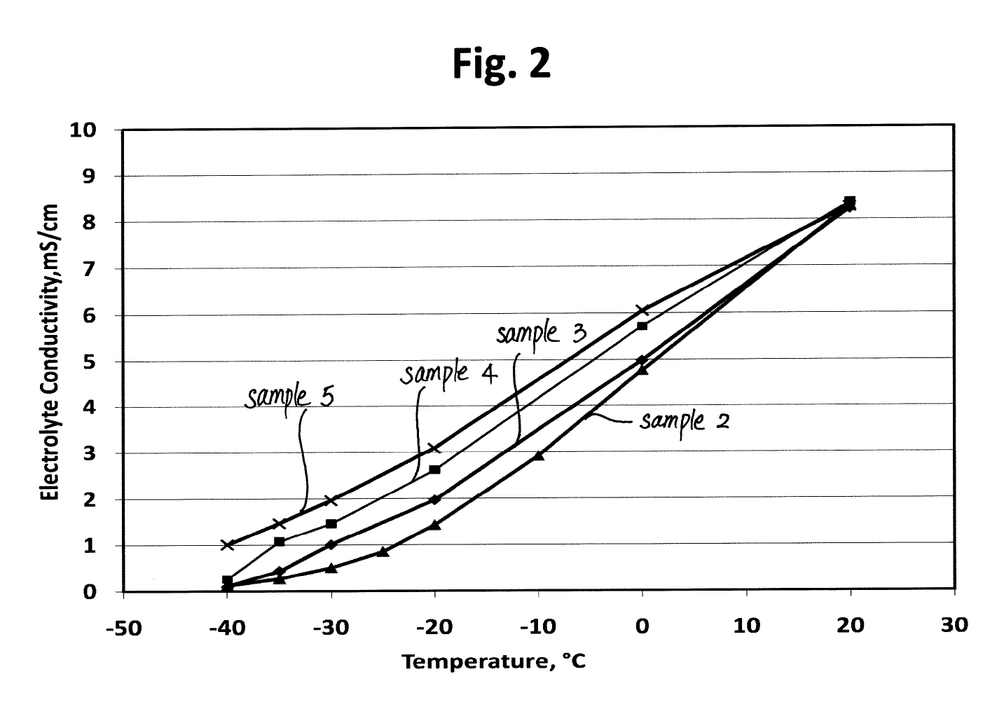

Electrolyte samples 1-5 were tested in a conductivity meter at room temperature, and the results are shown in Table 2 last column. The conductivities of samples 2-5 were somewhat less than sample 1, and the conductivities of samples 2-5 were similar to each other. To measure conductivity at low temperatures, coin cell batteries were formed with the electrode distance value adjusted to fit the conductivity tested by the conductivity meter at room temperature. AC impedance data from the coin cells at low temperature were converted into electrolyte solution resistance and correspondingly the conductivity of the electrolyte. The conductivity of the coin cell batteries with different electrolytes at different temperatures are shown in FIG. 2. The amount of EMC in the electrolytes positively impacted the conductivity of the electrolytes as the temperature was decreased from room temperature to −40° C., generally with the conductivity of sample 5>sample 4>sample 3>sample 2 in the temperature range tested.

Oxidation Potential Studies

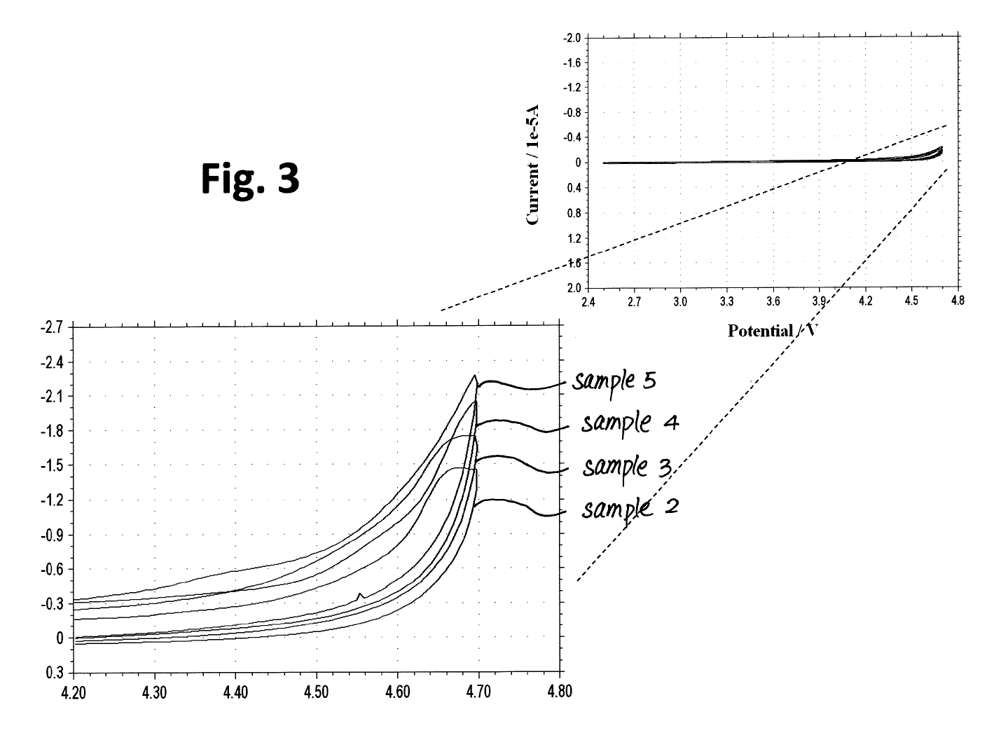

Cyclic voltametry measurements were performed in a three electrode beaker cell to evaluate oxidation of the electrolyte. The electrolyte samples 2-5 outlined in Table 2 were each filled in a three-electrode beaker cell with a glassy carbon (7 mm²) as working electrode and lithium metal as counter and reference electrodes. A separator was placed between the lithium metal electrode and the glassy carbon electrode with each side of the separator in contact with one of the electrodes. The electrodes and the separator were then soaked inside each of the electrolyte sample. The potential between the electrodes was gradually increased at a selected scan rate. The current flow between the electrodes was measured. A large increase in the negative current indicates that a reaction, specifically oxidation of the electrolyte, is taking place. After reaching the maximum selected potential, the potential was gradually reduced at a selected scan rate. If the reaction is reversible, a reduction reaction would take place with an opposite flow of current, i.e., positive current. Since the oxidation of the electrolyte is not a completely reversible process, the reduction currents are not seen at the same potentials. The batteries of samples 2-5 were scanned at 10 mV/sec in a voltage window of 2.5V to 4.7V and the results are shown in FIG. 3. The current generated with the samples generally did not sharply increase until values of the potential goes above 4.5V-4.6V. Samples with more EMC generally resulted in a greater current suggesting decreased stability presumably due to the oxidation of EMC at high voltages with the stability of sample 2>sample 3>sample 4>sample 5.

Cycling Performance at Different Temperatures

The electrolyte samples 2-5 outlined in Table 2 were assembled into coin cell batteries using a procedure outlined here. Specifically, a positive electrode was formed from lithium rich lithium metal oxide (LMO) powders, a negative electrode was formed from graphitic carbon or elemental lithium foil, and the electrolytes described herein are used to construct coin cell batteries. The coin cell batteries were formed by placing the positive electrode and negative electrode inside an argon filled glove box. A trilayer (polypropylene/polyethylene/polypropylene) micro-porous separator (2320 from Celgard, LLC, NC, USA) soaked with the selected electrolyte was placed between the positive electrode and the negative electrode. A few additional drops of the selected electrolyte were added between the electrodes. The electrodes were then sealed inside a 2032 coin cell hardware (Hohsen Corp., Japan) using a crimping process to form a coin cell battery. The resulting coin-cell battery was rested for 24 hours before going through various testing.

The LMO powder used for the positive electrode can be approximately represented by the formula Li₂MnO₃.(1−x) LiNiᵤMnᵥCo_{w}O₂. A first composition had x=0.5 and a second composition had x=0.3. The compositions had a metal halide coating. A discussion of the synthesis and testing of a range of cathode active materials with similar stoichiometries with or without additional oxide or halide coatings can be found in published U.S. Patent Application No. 2011/0052981A to Lopez et al., entitled “Layer-Layer Lithium Rich Complex Metal Oxides With High Specific Capacity And Excellent Cycling,” incorporated herein by reference. The LMO powders were mixed thoroughly with acetylene black (Super P™ from Timcal, Ltd, Switzerland) and graphite (KS 6™ from Timcal, Ltd) to form a homogeneous powder mixture. Separately, polyvinylidene fluoride PVDF (KF1300™ from Kureha Corp., Japan) was mixed with N-methyl-pyrrolidone (Sigma-Aldrich) and stirred overnight to form a PVDF-NMP solution. The homogeneous powder mixture was then added to the PVDF-NMP solution and mixed for about 2 hours to form homogeneous slurry. The slurry was applied onto an aluminum foil current collector to form a thin wet film and a positive electrode material was formed by drying the laminated current collector in a vacuum oven at 110° C. for about two hours to remove NMP. The positive electrode material was pressed between rollers of a sheet mill to obtain a positive electrode with desired thickness. The mixture comprised at least about 75 weight percent active metal oxide, at least about 3 weight percent acetylene black, at least about 1 weight percent graphite, and at least about 2 weight percent polymer binder.

The negative electrode was formed from graphitic carbon or elemental lithium. The graphitic carbon based negative electrodes comprised at least about 75 weight percent graphite and at least about 1 weight percent acetylene black with the remaining portion of the negative electrode being polymer binder. The acetylene black was initially mixed with NMP solvent to form a uniform dispersion. The graphite and polymer were added to the dispersion to form a slurry. The slurry was applied as a thin-film to a copper foil current collector. A negative electrode was formed by drying the copper foil current collector with the thin wet film in vacuum oven at 110° C. for about two hours to remove NMP. The negative electrode material was pressed between rollers of a sheet mill to obtain a negative electrode with desired thickness. Elemental lithium negative electrodes were formed from lithium foil having thickness of 125-150 microns.

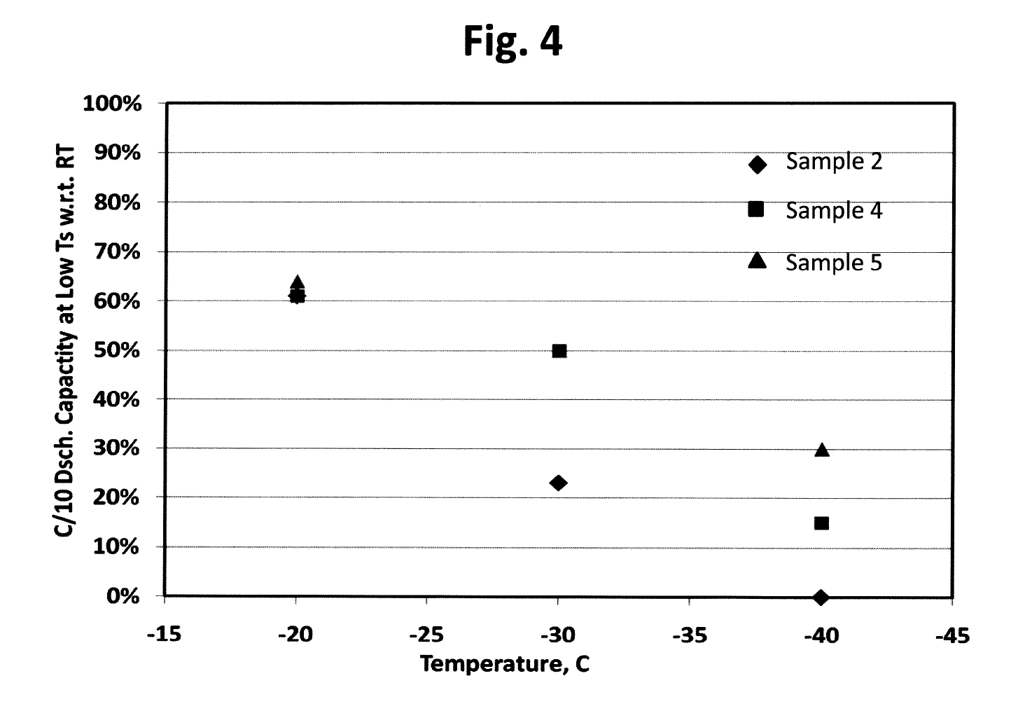

The coin cell batteries were then tested at different temperature conditions with different charge and discharge rates to evaluate the cycling performance of the sample electrolytes under various testing conditions. Specifically, coin cell batteries made from electrolyte samples 2, 4, and 5 were tested in low temperature conditions at C/10 rate with cycling between 2V to 4.5 V. The low temperature cycling performance was expressed in terms of the low temperature discharge capacity of the batteries as a percentage of the corresponding room temperature discharge capacity, and the results are shown in FIG. 4. The amount of EMC in the electrolytes positively influenced the low temperature cycling performance of the coin cell batteries with samples 4 and 5 having higher amount of EMC performed consistently better than the control battery with sample 2 as the temperature decreased from −20 to −40° C.

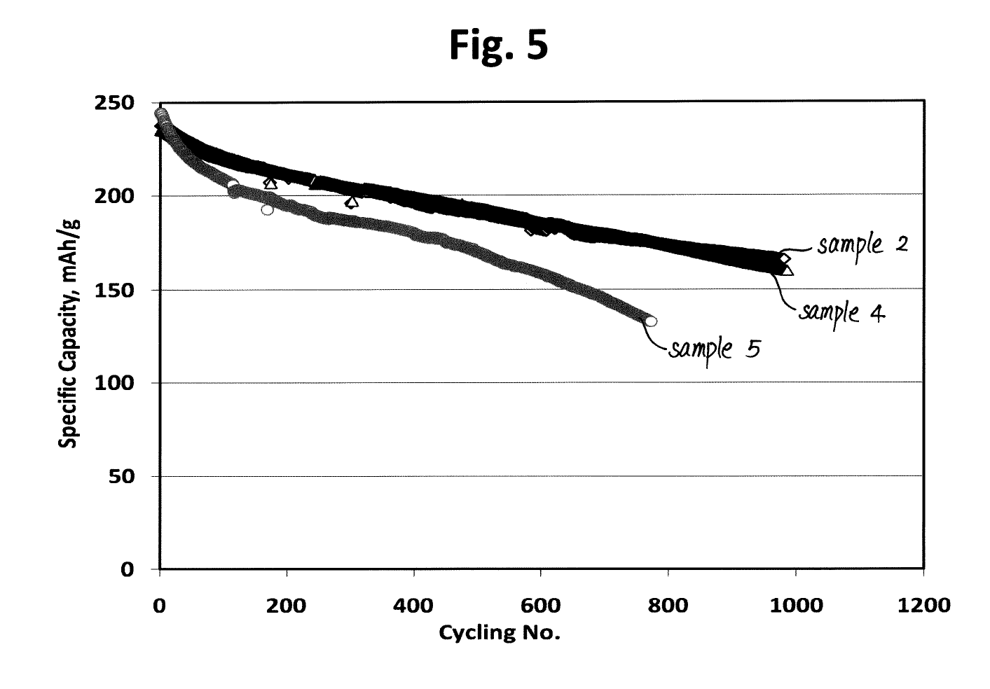

The batteries were further tested at charge/discharge rate of C/3 between 2V to 4.5V out to 1000 cycles at room temperature. During the first cycle, the batteries were charged to 4.6V at a rate of C/10 and then discharged at a rate of C/10 to complete a formation cycle. As shown in FIG. 5, specific capacity of the batteries generally maintained above 150 mAh/g out to 1000 cycles for samples 2 and 4. Additionally, the cycling performance of samples 2 and 4 batteries appeared to be very similar through the entire 1000 cycles. Batteries made from electrolyte sample 5 having about 30 wt % EMC however showed faster decrease in specific capacity compared to the control battery made with electrolyte sample 2 and to sample 2 battery having about 20 wt % EMC. Having 20% or less EMC in the electrolytes, therefore does not appear to significantly adversely affect the room temperature performance of the batteries in high voltage cycling over 1000 cycles, while having higher percentage of 30% EMC in the electrolyte did negatively affect the room temperature performance of the battery.

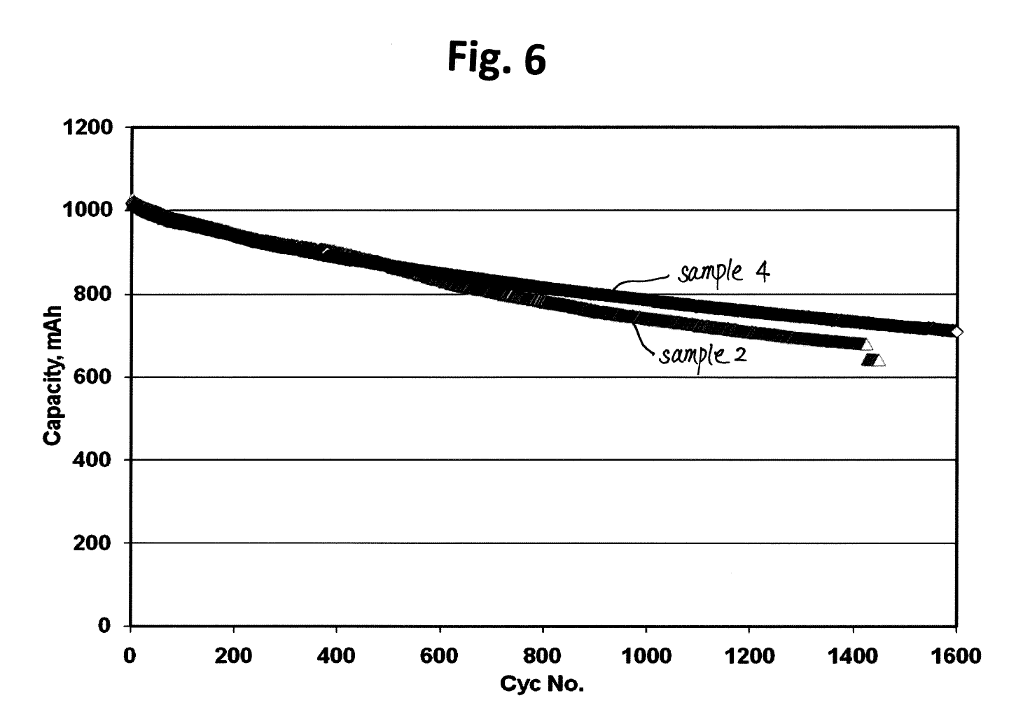

Batteries made from electrolyte samples 2 and 4 were made into 1 Ah capacity and cycled at 45° C. in the voltage window of 4.35V to 2.2 V at a rate of 1 C charge and 1 C discharge. During the first cycle, the batteries were charged to 4.6V at a rate of C/10 and then discharged at a rate of C/10 to complete a formation cycle. As shown in FIG. 6, comparable cycling stability of both batteries were observed with about 70% capacity retention out to 1600 cycles.

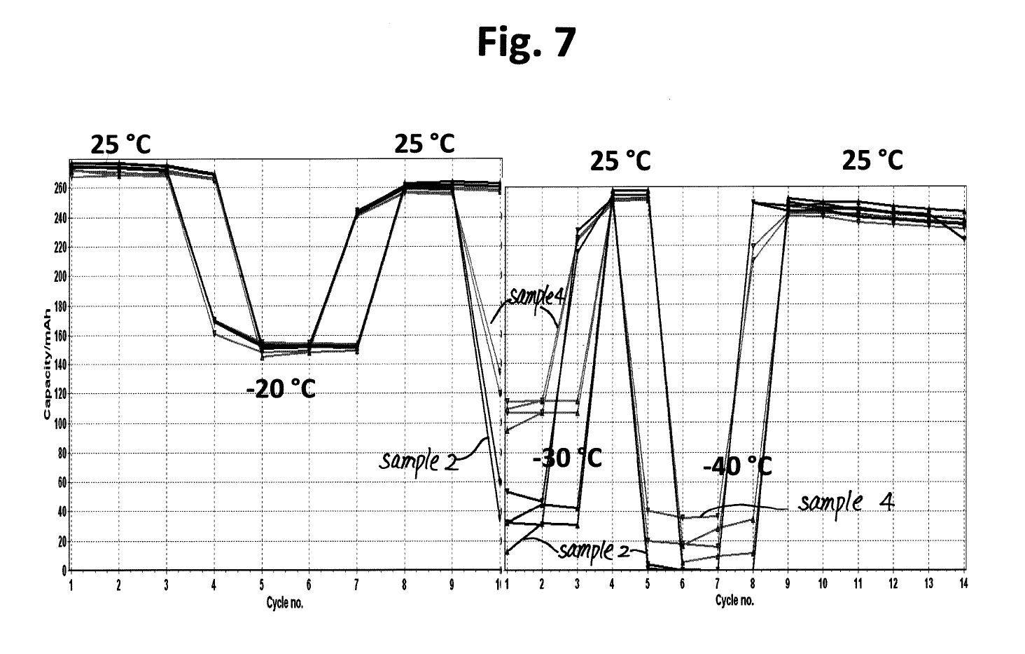

To test the cycling performance of the batteries under alternating temperature conditions, coin cell batteries made from samples 2 and 4 were cycled at C/10 rate between 2 to 4.5 V between 25° C. and −20° C., −30° C., or −40° C. As shown in FIG. 7, the batteries were first cycled at 25° C. before the temperature was lowered to −20° C. After cycling at −20° C. for a three cycles, the temperature was raised back to 25° C. before it went through pairs of cycles alternated between −30° C. and 25° C. and then −40° C. and again 25° C. cycles. Despite being tested at alternate low and moderate temperature conditions, both batteries maintained similar capacity at 25° C. before and after the low temperature cycles. The capacity of the batteries decreased as the cycling temperature was lowered from −20° C., to −30° C., and then to −40° C. Compared to the battery made from sample 2, the battery made from sample 4 appeared to have higher capacity during −20° C., −30° C., and −40° C. cycles. The battery made from sample 2 appears to have close to zero capacity during −40° C. cycles.

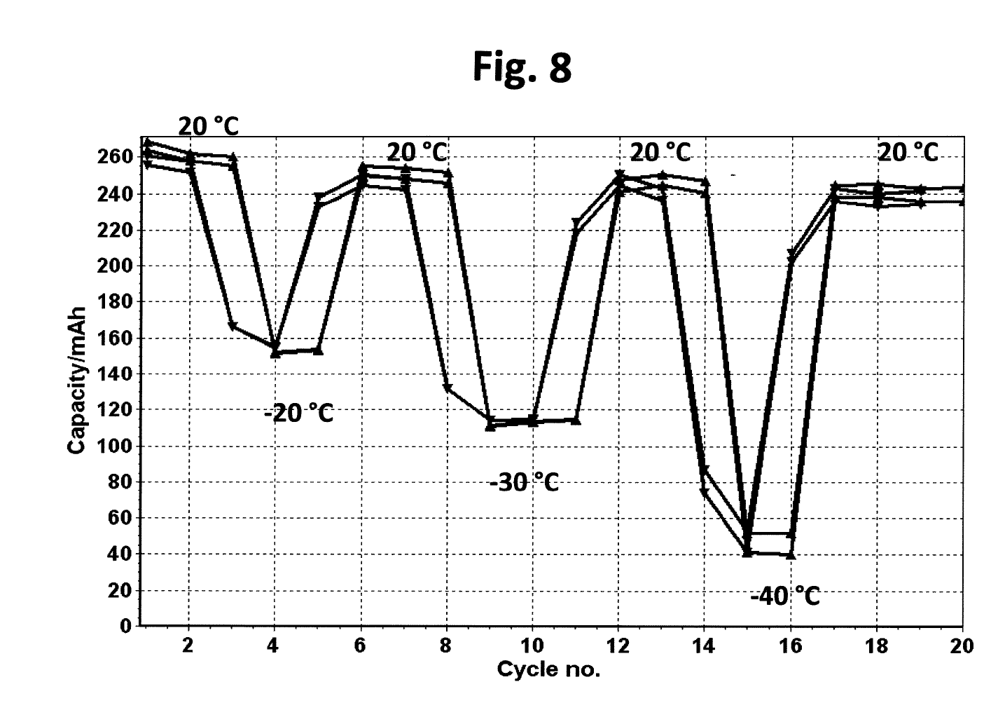

A battery made from sample 5 was tested under similar conditions with cycling temperatures alternating between 20° C. and −20, −30, or −40° C. As shown in FIG. 8, the battery appeared to have specific capacity above 35 mAh/g during −40° C. cycles. The addition of EMC into the electrolytes therefore appears to have significantly improved the cycling performance of the tested batteries under low temperature conditions, including −40° C.

In summary, batteries made from electrolyte that has more than 10 weight percent EMC appear to have maintained significant capacity at low temperature conditions including −30° C. and −40° C. without significant reduction or change in capacity at room temperature or high temperature, e.g. 45° C.

### Example 2

### High Voltage Electrolyte with Different Salt Concentrations

The effect of LiPF₆ concentration in the electrolyte on the performance of battery is evaluated. The LiPF₆ concentrations in samples 2 and 4 of example 1 were varied to formulate electrolyte samples shown in Table 3. The performances of these electrolytes were then tested under various conditions including low and high temperatures as well as accelerated charge/discharge rate and high voltage conditions.

TABLE 3

| | LiPF₆ | EC:DMC:EMC | LiDFOB | EMC |
|---|---|---|---|---|
| Electrolyte | (M) | (Wt Ratio) | (wt %) | (wt %) |
| Sample 2 | 1.5 | 1:2 | 3 | without EMC |
| Sample 2a | 1.35 | 1:2 | 3 | without EMC |
| Sample 2b | 1.2 | 1:2 | 3 | without EMC |
| Sample 4 | 1.17 | 1:2:0.74 | 2.5 | 20 |
| Sample 4a | 1.34 | 1:2:0.74 | 2.75 | 20 |
| Sample 4b | 1.5 | 1:2:0.74 | 3 | 20 |
| Sample 6 | 1.5 | FEC:DMC = 1:2 | 3 | without EMC |

*FEC is acronym for fluoroethylene carbonate.

Conductivity Studies

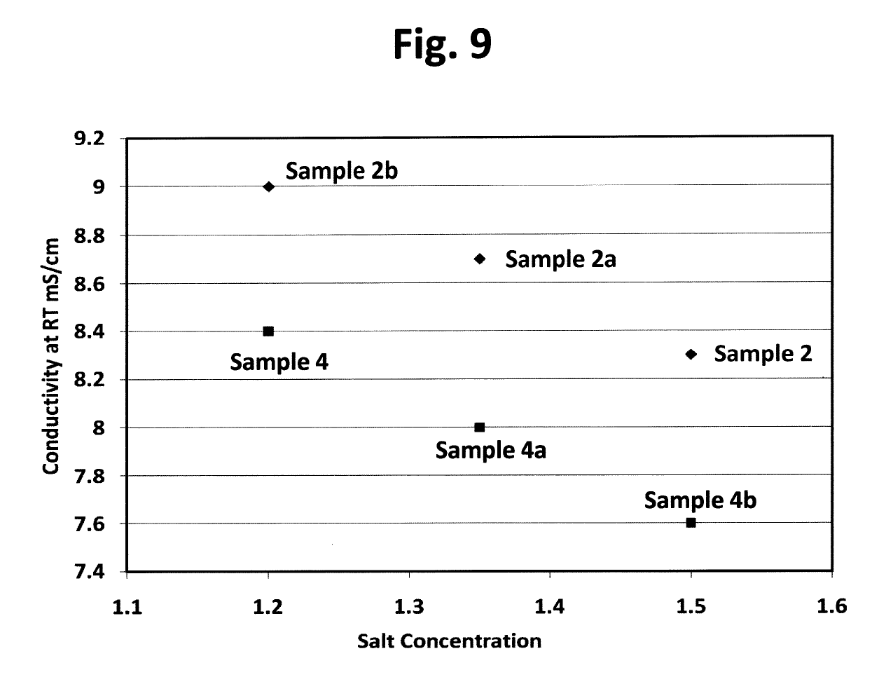

The electrolyte samples outlined in Table 3 were assembled into Li/Li coin cell batteries and tested for conductivity, as described in Example 1. As shown in FIG. 9, an increase in the concentration of LiPF₆ in the electrolytes appear to correspondingly decrease the conductivity of the coin cell batteries with the conductivity of sample 2b>sample 2a>sample 2 and the conductivity of sample 4>sample 4a>sample 4b. The salt concentration shown in FIG. 9 is based on LiPF₆ only, without the concentration value of lithium salt additive.

Cycling Performance at Different Temperatures

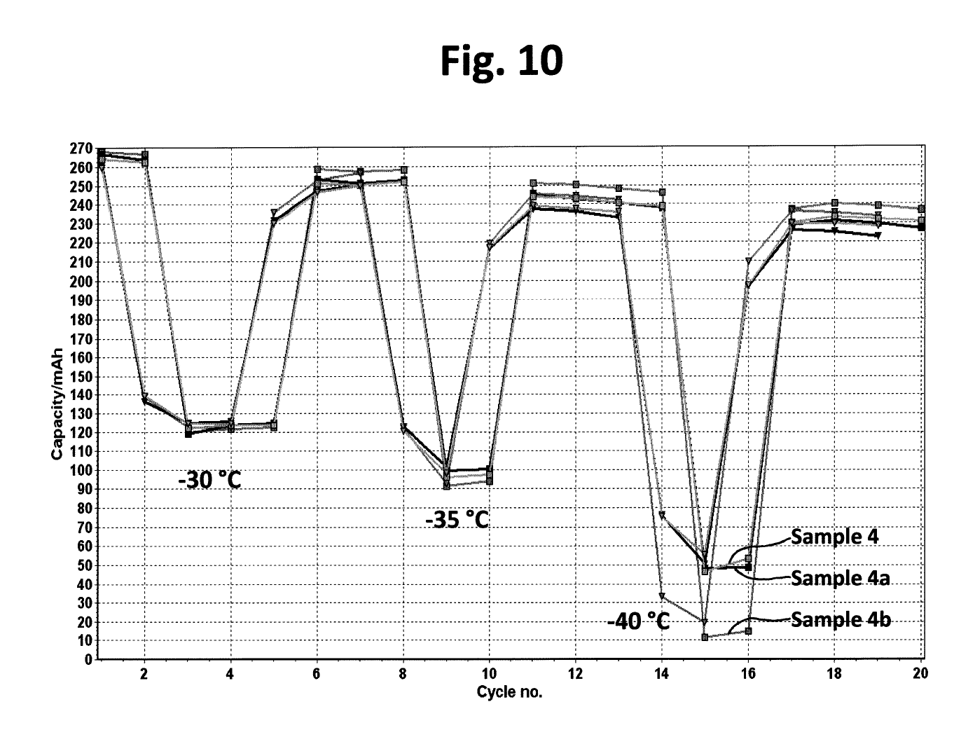

Coin cell batteries with electrolytes outlined in Table 3 were assembled with LMO as positive electrode using the procedure outlined in Example 1 above. The coin cell batteries were then tested at different temperature conditions with different charge and discharge rates to evaluate the cycling performance of the sample electrolytes under various testing conditions. For all of the cycling parameters described below, during the first cycle, the batteries were charged to 4.6V at a rate of C/10 and then discharged at a rate of C/10 to complete a formation cycle. Specifically, to test the cycling performance of the batteries under alternating temperature conditions, coin cell batteries made from samples 4, 4a, and 4b were cycled at C/10 rate between 2 to 4.5 V alternating between room temperature and −30° C., −35° C. or −40° C. cycles. As shown in FIG. 10, the batteries were first cycled at room temperature before the temperature was lowered to −30° C. After cycling at −30° C. for a few cycles, the temperature was raised back to room temperature before it went through cycles alternated between −35° C. and room temperature and −40° C. and room temperature cycles. Despite being tested at alternate low and moderate temperature conditions, all three batteries maintained similar capacity at room temperature before and after the low temperature cycles. The capacity of the batteries decreased as the cycling temperature was lowered from −30° C., to −35° C., and then to −40° C. Although all three batteries showed comparable capacity during −30° C. and −35° C. cycles, the battery made from sample 4b appeared to have lower capacity during −40° C. cycles, indicating the negative effect of a higher LiPF₆ concentration at very low temperatures.

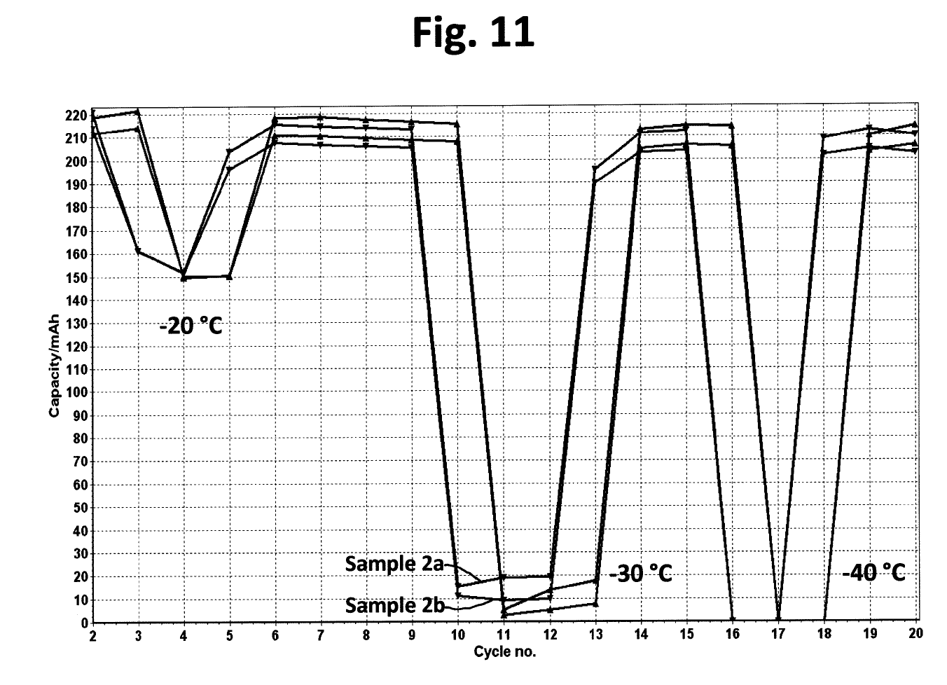

Batteries made from samples 2a and 2b were tested under similar conditions with cycling temperatures alternating between room temperature and −20, −30, or −40° C. As shown in FIG. 11, the batteries appeared to have good capacity during −20° C. cycles. Although during the −30° C. cycles, the capacity of the batteries appeared to be less than 20 mAh and during −40° C. cycles, there was no detectable activity. The addition of EMC into the electrolytes therefore appears to be the dominating factor to improve the cycling performance of the tested batteries at low temperature conditions, including −40° C. and the variance in salt concentration only played an auxiliary role in helping to improve low temperature performance.

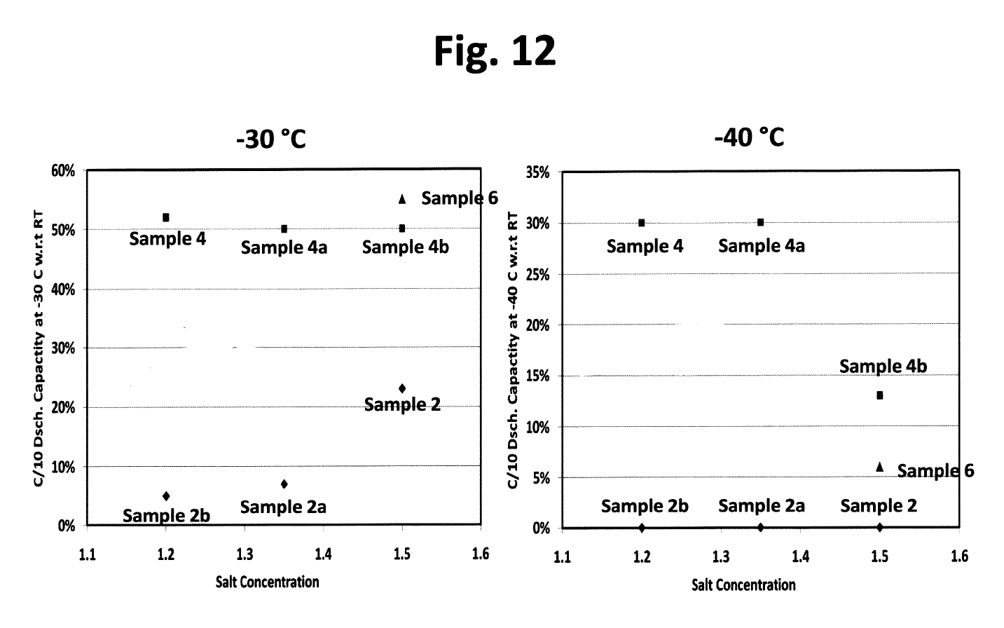

Batteries made from samples 2, 2a, 2b, 4, 4a, 4b, and 6 were tested at −30 and −40° C. at C/10 rate between 2 to 4.5 V. The low temperature capacity of the battery was converted to percentages of its respective room temperature capacity and the results are shown in FIG. 12. Sample 4, 4a, 4b, and 6 batteries appeared to have maintained about 50% of their respective room temperature capacities at −30° C. Sample 4 and 4a batteries appeared to have maintained about 30% of their respective room temperature capacities at −40° C., while sample 4b and 6 batteries appeared to have maintained only less than 15% and 7% of their room temperature capacity at −40° C. respectively. The sample 2a and 2b batteries appeared to have lost most of their capacities at −30° C., while sample 2 battery has maintained more than 20% capacity in comparison. In general, the samples batteries without EMC maintained significantly less capacity compared to the EMC added samples at low temperatures. At −40° C., the sample 2, 2a, and 2b batteries did not appear to have any measurable capacity. Sample 6 battery with FEC, however, has shown comparable low temperature performance at −30° C. to the EMC containing samples 4, 4a, and 4b. The capacity of sample 6 battery faded significantly at −40° C., but still better than sample 2, 2a, 2b batteries without EMC.

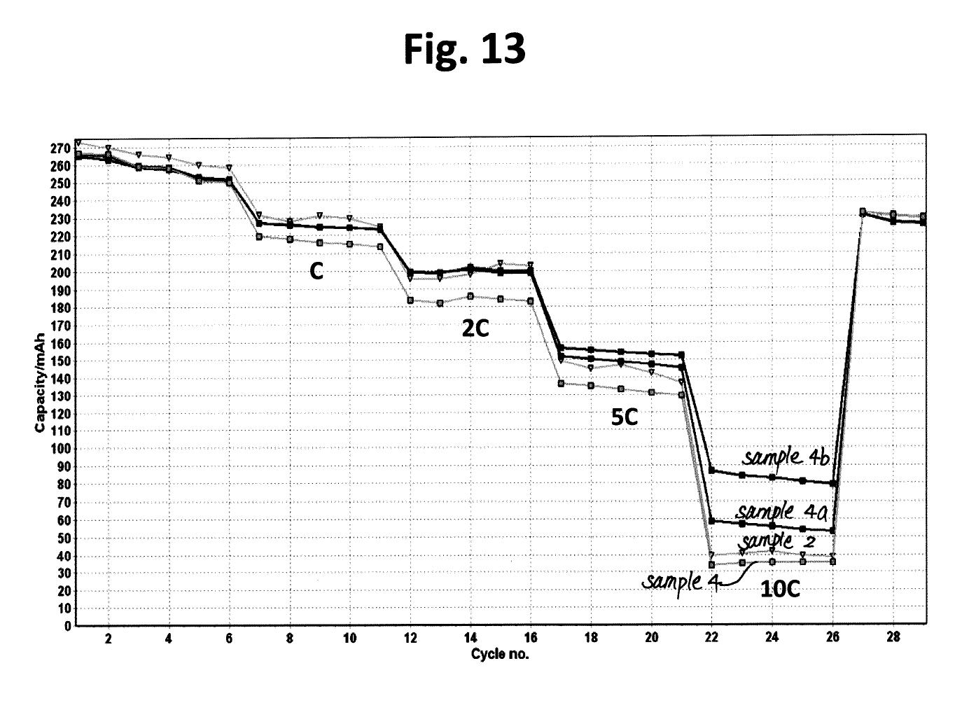

Batteries made from samples 4, 4a, and 4b were cycled at different charge and discharge rates at room temperature to evaluate the cycling performance of the batteries under different charge/discharge rates. Specifically, the batteries were cycled at C/10 charge/discharge for cycles 1 and 2, C/5 charge/discharge for cycles 3 and 4; C/5 charge C/3 discharge for cycles 5 and 6; C/5 charge and 1 C discharge for cycles 7 to 11, C/5 charge and 2 C discharge for cycles 12 to 16, C/5 charge and 5C discharge for cycles 17 to 21, C/5 charge and 10 C discharge for cycles 22 to 26, and C/5 charge C/3 discharge for cycles 27 to 29. As shown in FIG. 13, although the batteries performed similarly during initial cycles at C/3, the sample 4 battery with lower LiPF₆ concentration appeared to have lower capacity compared to sample 4a and 4b batteries as well as control sample 2 battery when the cycling rate is increased. The most pronounced difference appeared during the cycles at the higher 5 C and 10 C rates, with sample 4 battery showing significantly lower capacity than sample 4a battery which has lower capacity than sample 4b battery. The presence of EMC in the electrolyte appeared to improve the battery performance at high discharge rates. As shown in FIG. 13, although sample 4b has comparable concentration as sample 2 while sample 4a has lower salt concentration than sample 2, both sample 4a and 4b batteries appear to have better performance during the 5 C and 10 C high discharge cycles.

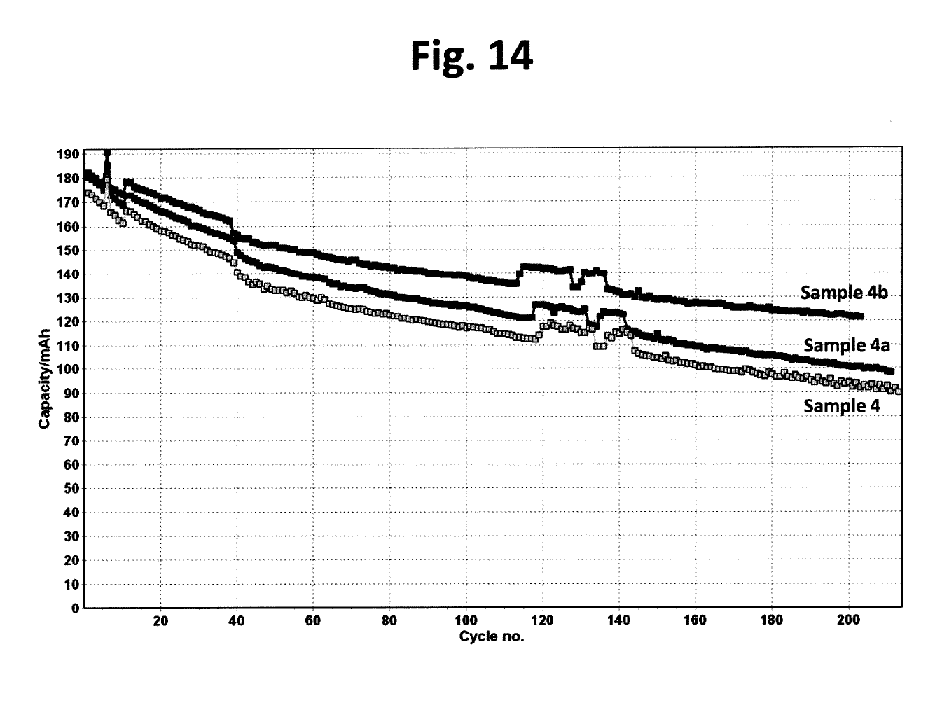

The impact of higher charge and discharge rates on the batteries were further evaluated by charging batteries at 1 C and discharging at 2 C. Specifically, batteries made from samples 4, 4a, and 4b were cycled at 1 C during charge and at 2 C during discharge between 2 and 4.5 V out to the 200 cycles. As shown in FIG. 14, sample 4 battery with lower LiPF₆ concentration appeared to have lower capacity compared to the sample 4a battery which has lower capacity than sample 4b battery.

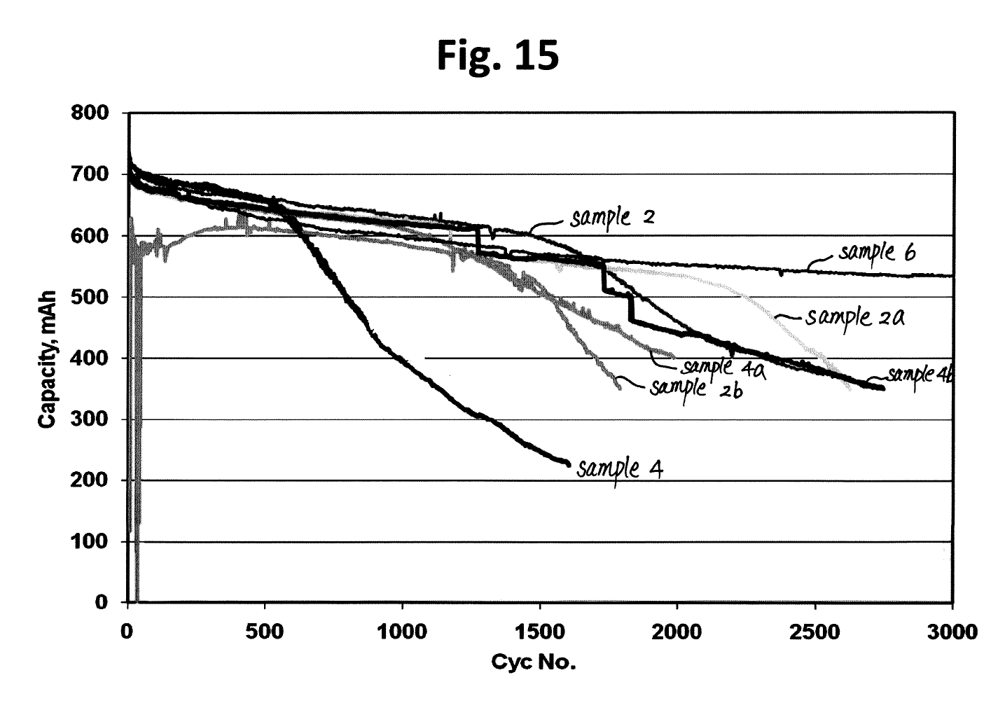

To test the long term cycling performance of the batteries at room temperature between 2.73 and 4.24 V, coin cell batteries made from samples 2, 2a, 2b, 4, 4a, 4b, and 6 were cycled at 1 C during charge and 2 C during discharge. As shown in FIG. 15, sample 4b battery appeared to have similar cycling stability to sample 2 battery, which is higher than the cycling stabilities of sample 4 and 4a batteries that have lower salt molarity. While sample 2 and 2a batteries appeared to have similar cycling stability, sample 2b battery with lower salt molarity appeared to have significantly lower stability, After 3000 cycles, sample 6 battery appeared to have maintained the most capacity despite the large number of cycles performed.

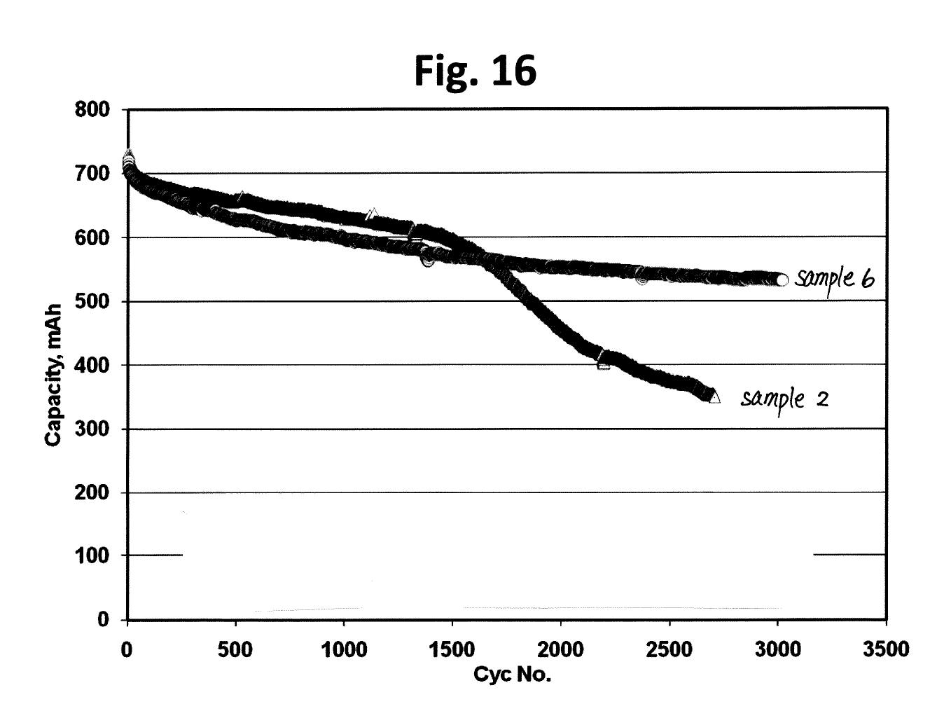

To test the long term cycling performance of the batteries at room temperature between 2.73 and 4.24 V, 1 A cells made from samples 2 and 6 were cycled at 1 C during charge and 2 C during discharge out to 3000 cycles. As shown in FIG. 16, sample 6 battery appeared to have similar cycling stability to sample 2 battery before 1500 cycles. Sample 2 battery lost about 50% capacity after 2700 cycles while sample 6 battery maintained more than 74% capacity after 3000 cycles. The electrolyte with FEC therefore appeared to have particularly good performance beyond 1500 cycles batteries at 1 C charge and 2 C discharge between 2.73 and 4.24 V.

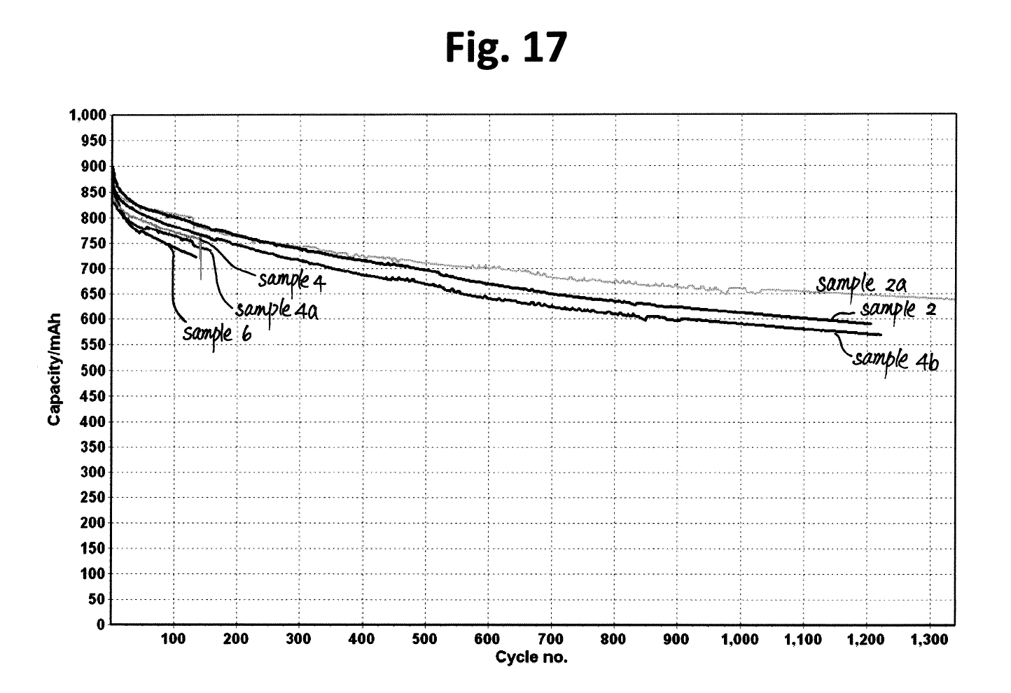

The long term cycling performance of the 1 Ah batteries made from samples 2, 2a, 4, 4a, 4b, and 6 were cycled at 1 C during charge and 2 C during discharge between 2.73 and 4.24 V at 45° C. As shown in FIG. 17, sample 4b battery showed similar cycling stability to sample 2 battery, which were better than sample 4 and 4a batteries. Sample 2a battery showed the best cycling stability among all tested batteries, while sample 6 battery showed the worst cycling stability at the elevated temperature.

In summary, although electrolytes with lower LiPF₆ concentration appear to have better cycling performance at very low temperatures such as −40° C., the cycling performance of batteries made from these electrolytes appear to suffer when cycled at higher charge/discharge rates. Electrolyte compositions that comprise an EC, DMC, and EMC ternary system balanced with the appropriate lithium salt concentrations appear to give consistently superior overall cycling performance under a variety of testing conditions including wide temperature range, fast discharge rate, stability during high voltage conditions out to many numbers of charge/discharge cycles. Additionally, electrolyte compositions containing a FEC and DMC binary system appear to have good low temperature performance and outstanding long term cycling abilities.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A lithium based battery comprising:
a positive electrode comprising a lithium metal oxide having a specific discharge capacity of at least about 200 mAh/g at a rate of C/3 when discharged from 4.5V to 2V,
a negative electrode,
a separator between the negative electrode and the positive electrode, and
an electrolyte comprising:
from about 1.05M to about 2.0M LiPF₆, LiBF₄ or combinations thereof,
a solvent consisting of fluoroethylene carbonate and dimethyl carbonate with a weight ratio of fluoroethylene carbonate to dimethyl carbonate of about 1:1 to about 1:4, and
one or more lithium salt additives in a total amount from about 0.01 weight percent to about 10 weight percent of the total weight of the electrolyte,
wherein the battery maintains at least 75% of its discharge energy density at the 2000th cycle at 1 C charge and 2 C discharge between 4.24V and 2.73V.

2. The battery of claim 1 wherein the lithium metal oxide is approximately represented by the formula Li_{1+b}Ni_{α}Mn_{β}Co_{γ}A_{δ}O_{2-z}F_{z}, where b ranges from about 0.01 to about 0.3, α ranges from about 0 to about 0.4, β range from about 0.2 to about 0.65, γ ranges from 0 to about 0.46, δ ranges from 0 to about 0.15 and z ranges from 0 to about 0.2 with the proviso that both α and γ are not zero, and where A is Mg, St, Ba, Cd, Zn, Al, Ga, B, Zr, Ti, Ca, Ce, Y, Nb, Cr, Fe, V, Li or combinations thereof.

3. The battery of claim 1 wherein the battery maintains at least 73% of its discharge energy density at the 3000th cycle at 1 C charge and 2 C discharge between 4.24V and 2.73V.

4. The battery of claim 1 wherein the weight ratio of fluoroethylene carbonate to dimethyl carbonate in the solvent of the electrolyte is from about 1:1.25 to 1:3.

5. The battery of claim 1 wherein the lithium salt additive of the electrolyte is represented by the formula: 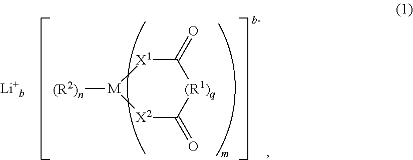
where b is the charge of the anion, m is a number from 1 to 4, n is a number from 1 to 8, q is 0 or 1, M is a transition metal or an element selected from groups 13-15 of the periodic, table, R¹ is an organic group, R² is a halogen or an organic group, X¹ and X² are independently O, S or NR⁴, and R⁴ is a halogen or an organic group.

6. The battery of claim 1 wherein the lithium salt additive of the electrolyte comprises lithium difluoro oxalato borate (LiDFOB), lithium bis(oxalato)borate (LiBOB), lithium fluorododecaborate (Li₂B₁₂HₓF₁₂₋ₓ(x=0-3)), lithium (bis)trifluoromethane sulfonimide, or a combination thereof.

7. The battery of claim 1 wherein the electrolyte further comprises one or more non-ionic organic additives in a total amount of no more than about 30 weight percent of the total weight of the electrolyte.

8. The battery of claim 7 wherein the non-ionic organic additive is selected from the group consisting of N,N-diethylamino trimethylsilane, 2,5-dihydrofuran, ethylmethyl sulfone, gamma-butyrolactone, monomer of polyethylene oxide, monomer of polyvinylidine fluoride, and mixtures thereof.

9. The battery of claim 1 wherein the solvent of the electrolyte contains no more than about 0.5 weight percent carbonate including additional halogenated carbonates besides fluoroethylene carbonate and dimethyl carbonate.

10. The battery of claim 1 wherein the battery has a discharge capacity at −30 degrees Celsius that is at least about 50% of the discharge capacity at room temperature.

11. The battery of claim 1 wherein the negative electrode comprises graphitic carbon, silicon based material, or a combination thereof.

12. An electrolyte for a lithium ion battery comprising:
from about 1.05M to about 2.0M LiPF₆, LiBF₄ or combinations thereof,
a solvent consisting of fluoroethylene carbonate and dimethyl carbonate with a weight ratio of fluoroethylene carbonate to dimethyl carbonate of about 1:1 to about 1:4, and
one or more lithium salt additives in a total amount from about 0.01 weight percent to about 10 weight percent of the total weight of the electrolyte,
wherein the solvent of the electrolyte contains no more than about 0.5 weight percent carbonate including additional halogenated carbonates besides fluoroethylene carbonate and dimethyl carbonate.

13. The electrolyte of claim 12 wherein the LiPF₆, LiBF₄ or combinations has a concentration of about 1.05M to about 1.6M.

14. The electrolyte of claim 12 wherein the weight ratio of fluoroethylene carbonate to dimethyl carbonate is from about 1:1.25 to 1:3.

15. The electrolyte of claim 12 wherein the lithium salt additive comprises lithium difluoro oxalato borate (LiDFOB), lithium bis(oxalato)borate (LiBOB), lithium fluorododecaborate (Li₂B₁₂HₓF₁₂₋ₓ(x=0-3)), lithium (bis)trifluoromethane sulfonimide, or a combination thereof.

16. The electrolyte of claim 12 further comprising one or more non-ionic organic additives in a total amount of no more than about 30 weight percent of the total weight of the electrolyte.

17. A lithium based battery, comprising:
a positive electrode comprising a lithium intercalation material,
a negative electrode,
a separator between the negative electrode and the positive electrode, and
an electrolyte comprising LiPF₆ and/or LiBF₄, a solvent consisting of fluoroethylene carbonate and dimethyl carbonate, and one or more lithium salt additives,
wherein the battery has a specific capacity of at least about 80 mAh/g relative to the weight of the positive electrode active material when discharged at −30° C. from 4.5V to 2 V at a rate of C/10.

18. The battery of claim 17 wherein the positive electrode comprises a lithium metal oxide approximately represented by the formula Li_{1+b}Ni_{α}Mn_{β}Co_{γ}A_{δ}O_{2-z}F_{z}, where b ranges from about 0.01 to about 0.3, α ranges from about 0 to about 0.4, β range from about 0.2 to about 0.65, γ ranges from 0 to about 0.46, δ ranges from 0 to about 0.15 and z ranges from 0 to about 0.2 with the proviso that both α and γ are not zero, and where A is Mg, Sr, Ba, Cd, Zn, Al, Ga, B, Zr, Ti, Ca, Ce, Y, Nb, Cr, Fe, V, Li or combinations thereof.

19. The battery of claim 17 wherein the negative electrode comprises graphitic carbon, silicon based material, or a combination thereof.

20. The battery of claim 17 wherein the LiPF₆, LiBF₄ or combination thereof has a concentration from about 1.05M to about 2.0M, wherein the weight ratio of fluoroethylene carbonate to dimethyl carbonate is from about 1:1 to about 1:4, wherein the total amount of one or more lithium salt additives is about 0.01 weight percent to about 10 weight percent of the total weight of the electrolyte, and wherein the lithium salt additive comprises lithium difluoro oxalato borate (LiDFOB), lithium bis(oxalato)borate (LiBOB), lithium fluorododecaborate (Li₂B₁₂HₓF₁₂₋ₓ(x=0-3)), lithium (bis)trifluoromethane sulfonimide, or a combination thereof.
